(19) United States
(12) Patent Application Publication
(10) Pub. No.: US 2017/0241351 A1
(43) Pub. Date: Aug. 24, 2017

(54) CONTROL DEVICE FOR INTERNAL-COMBUSTION ENGINE

(71) Applicant: HONDA MOTOR CO., LTD., Tokyo (JP)

(72) Inventors: Tadashi KUROTANI, Wako (JP); Kohei KUZUOKA, Wako (JP); Kenji SHIGETOYO, Wako (JP)

(73) Assignee: HONDA MOTOR CO., LTD., Tokyo (JP)

(21) Appl. No.: 15/421,435

(22) Filed: Feb. 1, 2017

(30) Foreign Application Priority Data
Feb. 23, 2016 (JP) 2016-031892

(51) Int. Cl. F02D 19/06; F02D 41/26

(52) U.S. Cl. CPC F02D 19/0655; F02D 41/26

(57) ABSTRACT

A control device for an internal-combustion engine to utilize low octane fuel and high octane fuel having a high octane value higher than a low octane value of the low octane fuel, the control device includes an inclination state sensor and a computer processor. The inclination state sensor detects an inclination state of a high octane fuel tank to store the high octane fuel. The computer processor acquires a remaining quantity of the high octane fuel in the high octane fuel tank. The computer processor restricts a power generated by the internal-combustion engine in accordance with the inclination state and the remaining quantity.

### CROSS-REFERENCE TO RELATED APPLICATIONS

The present application claims priority under 35 U.S.C. §119 to Japanese Patent Application No. 2016-031892, filed Feb. 23, 2016, entitled “Control Device For Internal-combustion Engine.” The contents of this application are incorporated herein by reference in their entirety.

### BACKGROUND

1. Field

The present disclosure relates to a control device for an internal-combustion engine.

2. Description of the Related Art

Hitherto, as a control device for an internal-combustion engine of this type, for example, configurations disclosed in Japanese Unexamined Patent Application Publication Nos. 2005-155469 and 2014-074337 have been known. In the control device disclosed in Japanese Unexamined Patent Application Publication No. 2005-155469, a basic high octane fuel ratio being a basic value of the ratio of the quantity of the high octane fuel to the total quantity of the low octane fuel and high octane fuel to be supplied into a cylinder is calculated in accordance with the number of rotations and load of the internal-combustion engine. Also, focusing on that knocking of the internal-combustion engine is more likely generated as the increasing rate of the load of the internal-combustion engine is higher, to restrict knocking, the basic high octane fuel ratio is corrected to increase on the basis of the increasing rate of the detected load of the internal-combustion engine. Accordingly, the ratio of the quantity of the high octane fuel is calculated. Also, the quantity of the high octane fuel to be supplied into the cylinder is controlled on the basis of the calculated ratio of the quantity of the high octane fuel.

Also, in the control device disclosed in Japanese Unexamined Patent Application Publication No. 2014-074337, to restrict knocking of the internal-combustion engine, the ratio of the quantity of the high octane fuel to the quantity of the low octane fuel to be supplied into the cylinder is calculated to increase as the detected load of the internal-combustion engine increases, and the quantity of the high octane fuel to be supplied into the cylinder is controlled on the basis of the calculated ratio of the quantity of the high octane fuel. In this case, the quantity of the low octane fuel to be supplied into the cylinder is controlled so that the ratio of the quantity of the low octane fuel to the quantity of the high octane fuel does not become the value 0 even when the load of the internal-combustion engine increases. Accordingly, the high octane fuel is saved.

### SUMMARY

According to a first aspect of the present invention, a control device for an internal-combustion engine that uses in combination low octane fuel stored in a low octane fuel tank and high octane fuel having a higher octane value than an octane value of the low octane fuel and stored in a high octane fuel tank, includes an inclination state acquiring unit, a remaining quantity acquiring unit, and an output limiting unit. The inclination state acquiring unit acquires an inclination state of the high octane fuel tank. The remaining quantity acquiring unit acquires a remaining quantity of the high octane fuel in the high octane fuel tank. The output limiting unit limits output of the internal-combustion engine in accordance with the acquired inclination state of the high octane fuel tank and the acquired remaining quantity of the high octane fuel.

According to a second aspect of the present invention, a control device for an internal-combustion engine to utilize low octane fuel and high octane fuel having a high octane value higher than a low octane value of the low octane fuel, the control device includes an inclination state sensor and a computer processor. The inclination state sensor detects an inclination state of a high octane fuel tank to store the high octane fuel. The computer processor acquires a remaining quantity of the high octane fuel in the high octane fuel tank. The computer processor restricts a power generated by the internal-combustion engine in accordance with the inclination state and the remaining quantity.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings.

FIG. 1 is an illustration schematically showing an internal-combustion engine to which a control device according to a first embodiment of the present disclosure is applied.

FIG. 2 is an enlarged cross-sectional view showing a second fuel tank and other components of the internal-combustion engine in FIG. 1.

FIG. 3 is an enlarged cross-sectional view showing an intake passage and other components of the second fuel tank in FIG. 2.

FIGS. 4A to 4C each illustrate a positional relationship between the liquid level of ethanol and a reservoir intake port in a case where the second fuel tank is inclined rightward. FIG. 4A is an enlarged cross-sectional view showing a case where the inclination angle of the second fuel tank is relatively small and the remaining quantity of the ethanol in a tank main body is extremely small. FIG. 4B is an enlarged cross-sectional view showing a case where the inclination angle of the second fuel tank is medium, and the remaining quantity of the ethanol in the tank main body is relatively small. FIG. 4C is an enlarged cross-sectional view in a case where the inclination angle of the second fuel tank is extremely large, and the remaining quantity of the ethanol in the tank main body is larger than that in FIG. 4B.

FIG. 5 is a block diagram showing an ECU and other components of the control device.

FIG. 6 is a flowchart showing engine control processing executed by the ECU.

FIG. 7 is a flowchart showing a subroutine of knocking control processing executed in step 11 in FIG. 6.

FIG. 8 is a flowchart showing processing subsequent to FIG. 7.

FIG. 9 is a flowchart showing a subroutine of non-knocking control processing executed in step 12 in FIG. 6.

FIG. 10 is a flowchart showing processing subsequent to FIG. 9.

FIG. 11 is a flowchart showing processing subsequent to FIG. 10.

FIG. 12 is a flowchart showing processing of controlling the intake air quantity of an engine.

FIG. 13 is a flowchart showing processing subsequent to FIG. 12.

FIG. 14 is an example of a map for calculating an upper limit request torque used in the processing in FIG. 13.

FIG. 15 is a flowchart showing processing for controlling the intake air quantity according to a second embodiment of the present disclosure.

FIG. 16 is an example of a map for calculating a basic value used in the processing in FIG. 15.

FIG. 17 is a flowchart showing processing subsequent to FIG. 15.

FIG. 18 is an example of a map for calculating a fourth correction coefficient used in the processing in FIG. 17.

FIG. 19 is a flowchart showing processing subsequent to FIG. 17.

FIG. 20 is an example of a map for calculating an upper limit request torque used in the processing in FIG. 19.

FIG. 21 provides timing charts showing an operation example of a control device according to the second embodiment.

### DESCRIPTION OF THE EMBODIMENTS

The embodiments will now be described with reference to the accompanying drawings, wherein like reference numerals designate corresponding or identical elements throughout the various drawings.

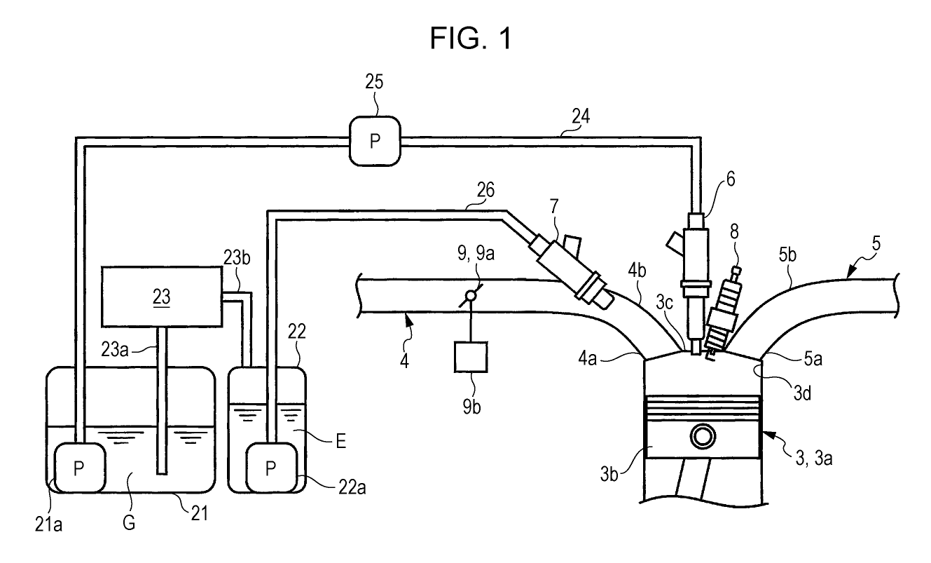

Desirable embodiments of the present disclosure are described below in detail with reference to the drawings. FIG. 1 shows an internal-combustion engine (hereinafter, referred to as “engine”) 3 to which a control device according to a first embodiment of the present disclosure is applied. The engine 3 is mounted as a power source in a four-wheel drive vehicle (not shown), and uses in combination gasoline G serving as low octane fuel and ethanol E serving as high octane fuel. The gasoline G is commercially available gasoline containing an ethanol component as a high octane component by about 10%, and is stored in a first fuel tank 21. The ethanol E contains the ethanol component by about 60%, has a higher octane value than that of the gasoline G, and is stored in a second fuel tank 22. As well known, the concentration of an ethanol component of fuel represents the octane value of the fuel. Higher the concentration of the ethanol component is, higher the octane value is. Low pressure pumps 21a and 22a are respectively provided in the first and second fuel tanks 21 and 22. The discharge pressure of the fuel by the low pressure pump 22a is set at a predetermined pressure PREF.

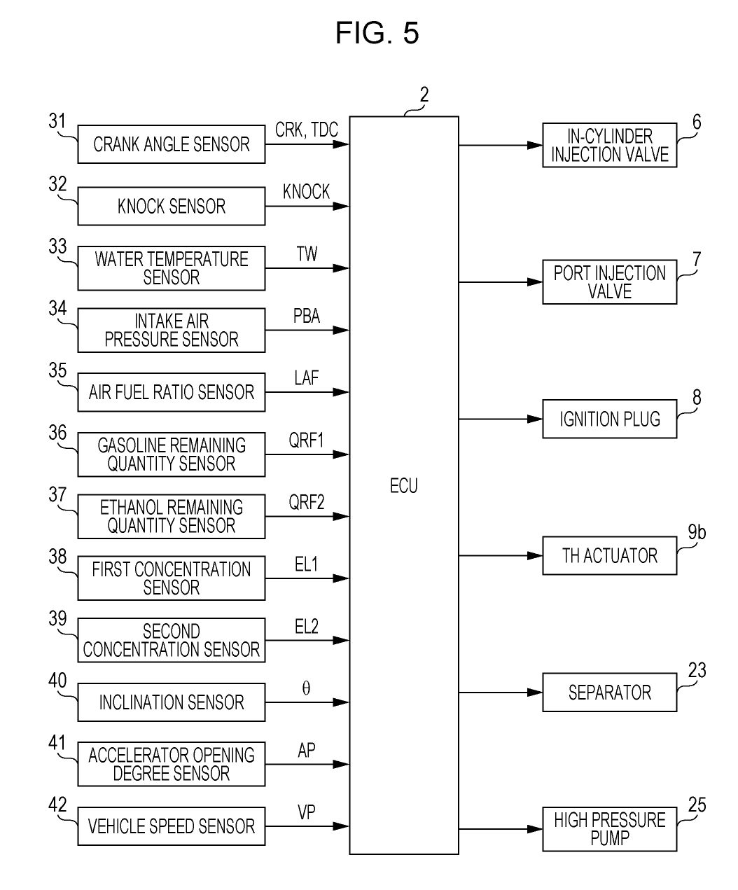

In this embodiment, the ethanol E is generated from the gasoline G by a separator 23. The separator 23 generates the ethanol E by separating the ethanol component from the gasoline G supplied from the first fuel tank 21 through a passage 23a, and supplies the generated ethanol E to the second fuel tank 22 through a passage 23b. The generation and supply operation of the ethanol E to the second fuel tank 22 by the separator 23 is controlled by an ECU 2 (described later) of the control device (see FIG. 5). For the separating method by the separator 23, a method using a separating film, a method using a catalyst, or any of other methods may be employed.

The engine 3 has, for example, four cylinders 3a (only one cylinder is shown). A combustion chamber 3d is formed between a piston 3b and a cylinder head 3c of each of the cylinders 3a. An intake air passage 4 is connected with the combustion chamber 3d through an intake air port 4a and an intake air manifold 4b. An exhaust air passage 5 is connected with the combustion chamber 3d through an exhaust air port 5a and an exhaust air manifold 5b.

Also, an in-cylinder injection valve 6 is provided at the cylinder head 3c, and a port injection valve 7 is provided at the intake air manifold 4b for each of the cylinders 3a. Further, an ignition plug 8 that ignites an air fuel mixture of the fuel and air generated in the combustion chamber 3d is provided at the cylinder head 3c for each of the cylinders 3a.

The in-cylinder injection valve 6 and the port injection valve 7 each have a typical configuration including a solenoid and a needle valve (either not shown). The in-cylinder injection valve 6 is arranged so that its tip end portion having an injection hole (not shown) faces the combustion chamber 3d. The in-cylinder injection valve 6 is connected with the low pressure pump 21a of the first fuel tank 21 through a gasoline supply passage 24 and a high pressure pump 25 provided in the middle of the gasoline supply passage 24. The port injection valve 7 is arranged so that its tip end portion having an injection hole (not shown) faces the intake air port 4a. The port injection valve 7 is connected with the low pressure pump 22a of the second fuel tank 22 through an ethanol supply passage 26.

With the above-described configurations, the gasoline G is supplied to the in-cylinder injection valve 6 from the first fuel tank 21 through the low pressure pump 21a and the gasoline supply passage 24, with an increased pressure by the high pressure pump 25, and is directly injected from the in-cylinder injection valve 6 to the combustion chamber 3d. The pressure of the gasoline G to be supplied to the in-cylinder injection valve 6 is changed by controlling the operation of the high pressure pump 25 by the ECU 2. Also, the ethanol E is supplied to the port injection valve 7 from the second fuel tank 22 through the low pressure pump 22a and the ethanol supply passage 26, and is injected to the intake air port 4a from the port injection valve 7.

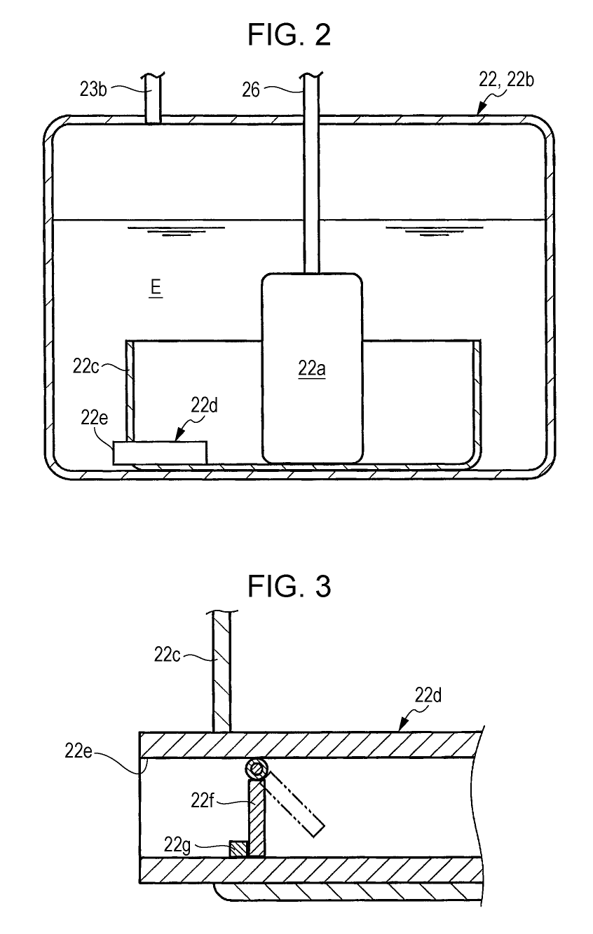

Next, the second fuel tank 22 is described in detail. As shown in FIG. 2, the second fuel tank 22 includes a tank main body 22b that stores the ethanol E, and a reservoir 22c provided in the tank main body 22b. The reservoir 22c prevents the low pressure pump 22a from no longer sucking the ethanol E as a result that the second fuel tank 22 is inclined with the vehicle during turning, accelerating and decelerating, uphill traveling, and downhill traveling of the vehicle.

To be specific, the reservoir 22c is formed in a pot-like shape, and its bottom portion is integrally attached to the bottom surface of the tank main body 22b. The low pressure pump 22a is provided to suck the ethanol E in the reservoir 22c and discharge the ethanol E through the ethanol supply passage 26 toward the port injection valve 7. A tube-like intake passage 22d is integrally provided at the center in the front-rear direction of the wall surface on the left of the bottom portion of the reservoir 22c. The inside of the intake passage 22d communicates with the inside of the tank main body 22b at a reservoir intake port 22e formed at one end portion of the intake passage 22d, and communicates with the reservoir 22c at a discharge port formed at the other end portion of the intake passage 22d.

As shown in FIG. 3, a flapper 22f that opens and closes the intake passage 22d is provided in the intake passage 22d. A stopper 22g that restricts rotation of the flapper 22f is provided in the intake passage 22d, at a portion on the tank main body 22b side with respect to the flapper 22f. The flapper 22f is provided rotatably between an open position indicated by a two-dot chain line and a closed position indicated by a solid line in FIG. 3.

When the liquid level of the ethanol E in a portion on the intake passage 22d side in the tank main body 22b is higher than the liquid level of the ethanol E in a portion on the intake passage 22d side in the reservoir 22c, the flapper 22f is rotated to the open position by being pressed with the liquid pressure of the ethanol E in the tank main body 22b introduced into the intake passage 22d. Accordingly, the intake passage 22d is opened by the flapper 22f, and hence the ethanol E in the tank main body 22b flows into the reservoir 22c through the intake passage 22d.

In contrast, when the liquid level of the ethanol E in the portion on the intake passage 22d side in the reservoir 22c is higher than the liquid level of the ethanol E in the portion on the intake passage 22d side in the tank main body 22b, the flapper 22f is rotated to the closed position side by being pressed with the liquid pressure of the ethanol E in the reservoir 22c introduced into the intake passage 22d, and is held at the closed position by contacting the stopper 22g. Accordingly, the intake passage 22d is closed by the flapper 22f, and hence the ethanol E in the reservoir 22c is prevented from flowing into the tank main body 22b through the intake passage 22d.

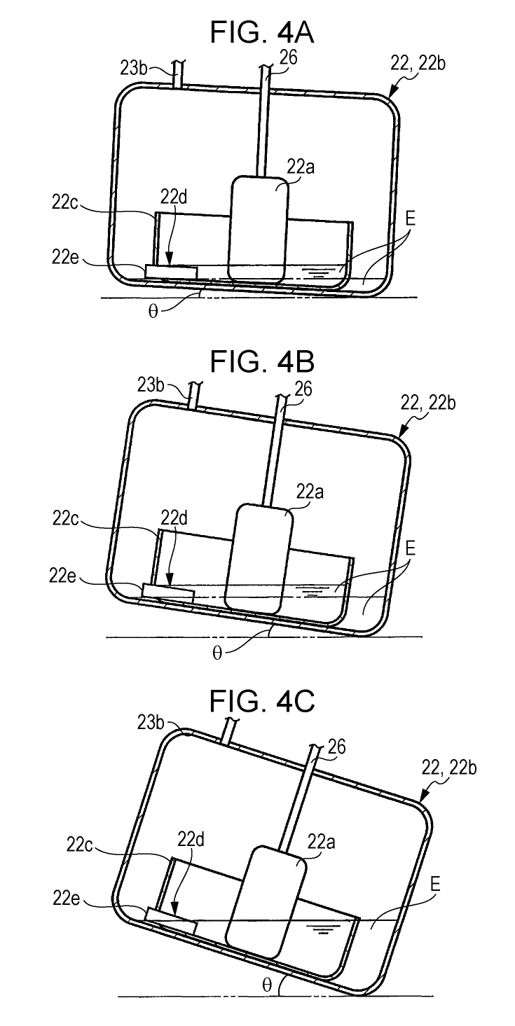

Also, FIGS. 4A to 4C each illustrate the positional relationship between the liquid level of the ethanol E in the tank main body 22b and the reservoir intake port 22e of the intake passage 22d in a case where the second fuel tank 22 is inclined rightward with respect to the horizontal line (indicated by a two-dot chain line) extending in the left-right direction. The situation in which the second fuel tank 22 is inclined rightward occurs when the vehicle turns left and hence the second fuel tank 22 is inclined with the vehicle by centrifugal force.

In particular, FIG. 4A illustrates the above-described positional relationship between the liquid level of the ethanol E in the tank main body 22b and the reservoir intake port 22e in a case where the inclination angle θ of the second fuel tank 22 (hereinafter, referred to as “second fuel tank inclination angle”) in this case is relatively small, and the remaining quantity of the ethanol E in the tank main body 22b (hereinafter, referred to as “main body ethanol remaining quantity”) is extremely small. FIG. 4B illustrates the positional relationship in a case where the second fuel tank inclination angle θ is medium, and the main body ethanol remaining quantity is relatively small. FIG. 4C illustrates the positional relationship in a case where the second fuel tank inclination angle θ is extremely large, and the main body ethanol remaining quantity is larger than that in FIG. 4B. In FIGS. 4A and 4B, the liquid level of the ethanol E in the tank main body 22b is indicated by a one-dot chain line, and the liquid level of the ethanol E in the reservoir 22c is indicated by a solid line.

As shown in FIGS. 4A to 4C, as the main body ethanol remaining quantity (the remaining quantity of the ethanol E in the tank main body 22b) is smaller, the reservoir intake port 22e is positioned further above the liquid level of the ethanol E in the tank main body 22b when the second fuel tank inclination angle θ is smaller. The reservoir intake port 22e is not immersed in the ethanol E, and hence the ethanol E in the tank main body 22b cannot flow into the reservoir 22c. In such a case, the ethanol E currently stored in the reservoir 22c is sucked by the low pressure pump 22a. However, the quantity of the ethanol E that can be stored in the reservoir 22c is relatively small.

Since the intake passage 22d is arranged with respect to the reservoir 22c as described above, the situation in which the reservoir intake port 22e is positioned above the liquid level of the ethanol E in the tank main body 22b does not basically occur during right turning, accelerating and decelerating, uphill traveling, and downhill traveling of the vehicle.

Also, the first fuel tank 21 is configured similarly to the second fuel tank 22. As described above, based on the configuration in which the ethanol E is generated from the gasoline G by the separator 23, the remaining quantity of the gasoline G in the first fuel tank 21 tends to be larger than the remaining quantity of the ethanol E in the second fuel tank 22. Also, if the remaining quantity of the gasoline G in the first fuel tank 21 becomes small, this is indicated by an indicator (not shown) at driver's seat of the vehicle, to recommend the driver to refuel. Therefore, in the first fuel tank 21, unlike the above-described case of the second fuel tank 22, even when the first fuel tank 21 is inclined during left turning of the vehicle, the phenomenon in which the gasoline G in the tank main body of the first fuel tank 21 does not flow into the reservoir does not basically occur.

Further, a throttle valve 9 is provided in the intake air passage 4 of the engine 3. The throttle valve 9 includes a valve body 9a that opens and closes the intake air passage 4, and a TH actuator 9b that drives the valve body 9a. The TH actuator 9b is configured of, for example, an electric motor, and is connected with the ECU 2 (see FIG. 5). The opening degree of the throttle valve 9 is changed by the ECU 2, and hence the quantity of the intake air flowing into the cylinder 3a through the intake air passage 4 is controlled.

Also, the engine 3 is provided with a crank angle sensor 31, a knock sensor 32, and a water temperature sensor 33. The crank angle sensor 31 outputs a CRK signal and a TDC signal being pulse signals to the ECU 2 along with the rotation of a crankshaft (not shown) (see FIG. 5). The CRK signal is output, for example, every predetermined rotation angle of the crankshaft (hereinafter, referred to as “crank angle,” for example, 1°). The ECU 2 calculates the number of rotations NE of the engine 3 (hereinafter, referred to as “engine speed”) on the basis of the CRK signal. Also, the TDC signal is a signal indicative of that the piston 3b in one of the cylinders 3a is positioned near the top dead center at start of an intake air stroke. When the number of cylinders 3a is four like this embodiment, the TDC signal is output every crank angle of 180°.

The above-described knock sensor 32 is configured of, for example, a piezoelectric element, and is provided at a cylinder block of the engine 3. The knock sensor 32 detects a knock intensity KNOCK being the intensity of knocking of the engine 3, and outputs the detection signal to the ECU 2. The water temperature sensor 33 detects a temperature TW of cooling water of the engine 3 (hereinafter, referred to as “engine water temperature”), and outputs the detection signal to the ECU 2.

Also, an intake air pressure sensor 34 is provided downstream of the throttle valve 9 in the intake air passage 4. An air fuel ratio sensor 35 is provided in the exhaust air passage 5. The intake air pressure sensor 34 detects an intake air pressure PBA being the pressure in the intake air passage 4, and outputs the detection signal to the ECU 2. The ECU 2 makes retrieval from a predetermined map (not shown) in accordance with the calculated engine speed NE and the detected intake air pressure PBA, and hence calculates an intake air quantity QAIR of the intake air to be sucked into the cylinder 3a. The above-described air fuel ratio sensor 35 detects an air fuel ratio LAF of an air fuel mixture combusted in the combustion chamber 3d, and outputs the detection signal to the ECU 2.

Further, the engine 3 is provided with a cylinder discrimination sensor (not shown). The cylinder discrimination sensor outputs a cylinder discrimination signal being a pulse signal for discriminating the cylinder to the ECU 2. The ECU 2 calculates an actual crank angle position being an actual rotation angle position of the crankshaft for each cylinder 3a on the basis of the cylinder discrimination signal, the CRK signal, and the TDC signal. In this case, the actual crank angle position is calculated at a rotation angle position of the crankshaft with reference to the TDC signal of each cylinder 3a, and is calculated as the value 0 at generation of the TDC signal.

Also, a gasoline remaining quantity sensor 36 and an ethanol remaining quantity sensor 37 of, for example, float type are provided in the first and second fuel tanks 21 and 22, respectively. The gasoline remaining quantity sensor 36 detects a remaining quantity QRF1 of the gasoline G stored in the first fuel tank 21 (hereinafter, referred to as “gasoline remaining quantity”), and outputs the detection signal to the ECU 2. The ethanol remaining quantity sensor 37 detects the main body ethanol remaining quantity QRF2 (the remaining quantity of the ethanol E in the tank main body 22b), and outputs the detection signal to the ECU 2.

Further, a first concentration sensor 38 and a second concentration sensor 39 of, for example, capacitance type are provided in the first and second fuel tanks 21 and 22, respectively. The first concentration sensor 38 detects a concentration EL1 of the ethanol component contained in the gasoline G stored in the first fuel tank 21 (hereinafter, referred to as “first ethanol concentration”), and outputs the detection signal to the ECU 2. The second concentration sensor 39 detects a concentration EL2 of the ethanol component contained in the ethanol E stored in the reservoir 22c of the second fuel tank 22 (hereinafter, referred to as “second ethanol concentration”), and outputs the detection signal to the ECU 2. Alternatively, as a matter of course, other appropriate sensors, for example, optical sensors may be used as the first and second concentration sensors 38 and 39.

Also, an inclination sensor 40 of, for example, capacitance type is provided in the second fuel tank 22. The inclination sensor 40 detects the second fuel tank inclination angle θ (the rightward inclination angle of the second fuel tank 22 with respect to the horizontal line extending in the left-right direction of the vehicle), and outputs the detection signal to the ECU 2. Alternatively, as a matter of course, another appropriate sensor, for example, a sensor of pendulum type may be used for the inclination sensor 40.

Also, an accelerator opening degree sensor 41 outputs a detection signal that represents an operation amount AP of an accelerator pedal (not shown) of the vehicle (hereinafter, referred to as “accelerator opening degree”) to the ECU 2. A vehicle speed sensor 42 outputs a detection signal that represents a vehicle speed VP of the vehicle to the ECU 2.

The ECU 2 is configured of a microcomputer including a CPU, a RAM, a ROM, and an I/O interface (either not shown). The ECU 2 controls the fuel injection time and injection timing of each of the in-cylinder injection valve 6 and the port injection valve 7, the ignition timing of the ignition plug 8, and the opening degree of the throttle valve 9, and also controls the operation of the separator 23 and the operation of the high pressure pump 25, in accordance with the detection signals from the various sensors 31 to 42 by following a control program stored in the ROM.

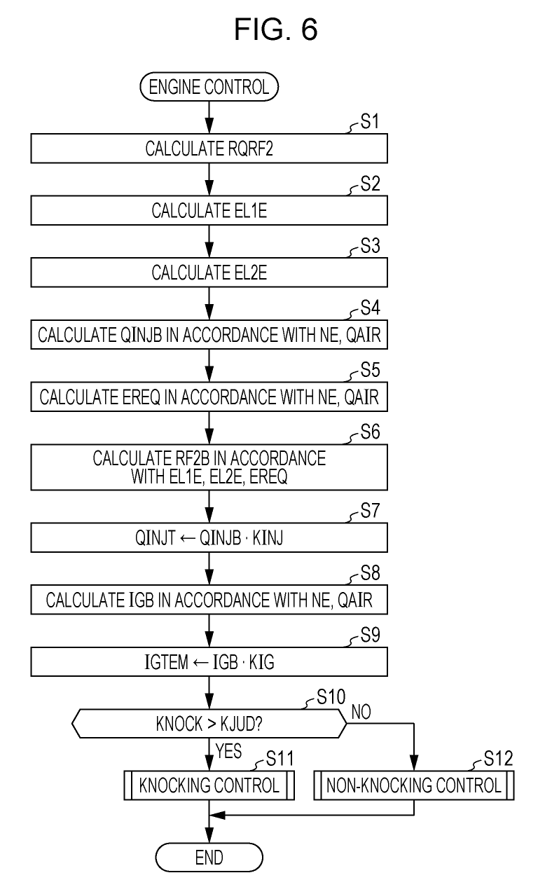

Next, processing to be executed by the ECU 2 is described with reference to FIGS. 6 to 14. Engine control processing shown in FIG. 6 is processing for controlling the injection time of each of the in-cylinder injection valve 6 and the port injection valve 7, and the ignition timing of the ignition plug 8, for each of the cylinders 3a. This processing is repeatedly executed in synchronization with generation of the TDC signal. First, in step 1 (in the drawing, indicated as “S1” which will be similar in the following description), the detected main body ethanol remaining quantity QRF2 is divided by the sum of the detected gasoline remaining quantity QRF1 and ethanol remaining quantity QRF2, and hence an ethanol remaining quantity ratio RQRF2 is calculated [RQRF2=QRF2/(QRF1+QRF2)].

Then, the detected first ethanol concentration EL1 is corrected and hence a first estimated ethanol concentration EL1E is calculated (step 2). In addition, the detected second ethanol concentration EL2 is corrected, and hence a second estimated ethanol concentration EL2E is calculated (step 3). In this case, the first and second estimated ethanol concentrations EL1E and EL2E are corrected to smaller values as generation of knocking in the engine 3 is judged in step 10 (described later).

Then, retrieval is made from a predetermined map (not shown) in accordance with the engine speed NE and the calculated intake air quantity QAIR, and hence a basic fuel injection quantity QINJB is calculated (step 4). Then, retrieval is made from a predetermined map (not shown) in accordance with the engine speed NE and the intake air quantity QAIR, and hence a request ethanol concentration EREQ is calculated (step 5). The request ethanol concentration EREQ is a request value for the ethanol concentration of the fuel to be supplied into the combustion chamber 3d. In the above-described map, the request ethanol concentration EREQ is set at a larger value as the intake air quantity QAIR is larger.

Then, retrieval is made from a predetermined map (not shown) in accordance with the first and second estimated ethanol concentrations EL1E and EL2E respectively calculated in aforementioned steps 2 and 3 and the request ethanol concentration EREQ calculated in step 5, and hence a basic port injection ratio RF2B is calculated (step 6). The basic port injection ratio RF2B is a basic value of the ratio of the port injection quantity to the sum of the in-cylinder injection quantity and the port injection quantity. In the above-described map, the basic port injection ratio RF2B is set so that the ethanol concentration in the fuel to be supplied into the combustion chamber 3d meets the request ethanol concentration EREQ.

Then, the basic fuel injection quantity QINJB calculated in aforementioned step 4 is multiplied by a correction coefficient KINJ, and hence a total fuel injection quantity QINJT is calculated (step 7). The total fuel injection quantity QINJT is a target value of the sum of the injection quantity of the in-cylinder injection valve 6 (hereinafter, referred to as “in-cylinder injection quantity”) and the injection quantity of the port injection valve 7 (hereinafter, referred to as “port injection quantity”). The correction coefficient KINJ is set on the basis of a stoichiometric mixture ratio correction coefficient and an air fuel ratio correction coefficient. If the ethanol concentration in the fuel is different, the mass ratio of the fuel that causes the air fuel ratio LAF to be a stoichiometric equivalent air fuel ratio with respect to the intake air quantity QAIR (hereinafter, referred to as “stoichiometric mixture ratio”) is different. With regard to this, the stoichiometric mixture ratio correction coefficient is for compensating the influence of the different mass ratio. For example, the stoichiometric mixture ratio correction coefficient is calculated as described below.

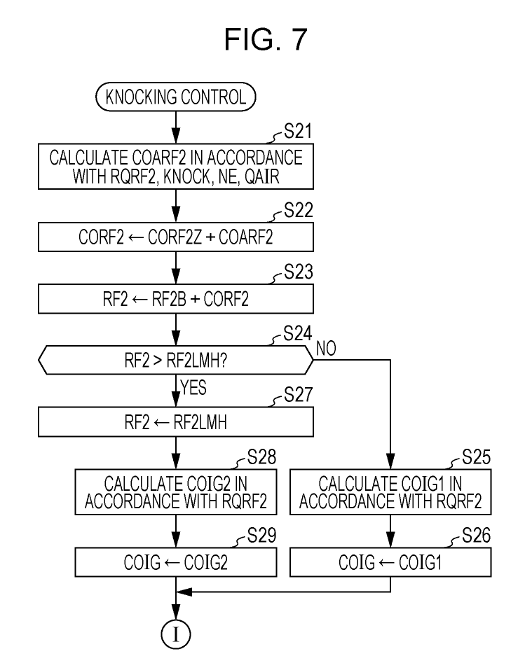

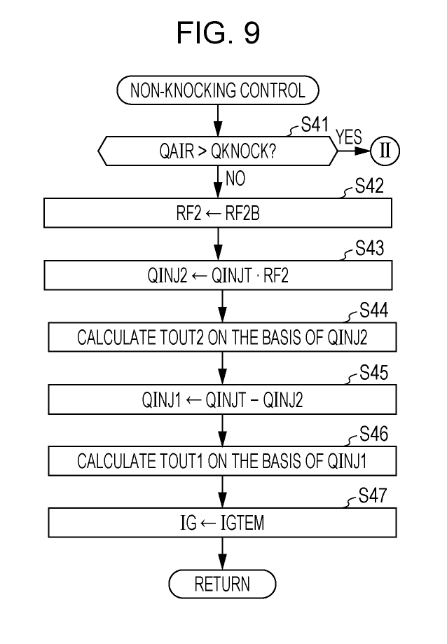

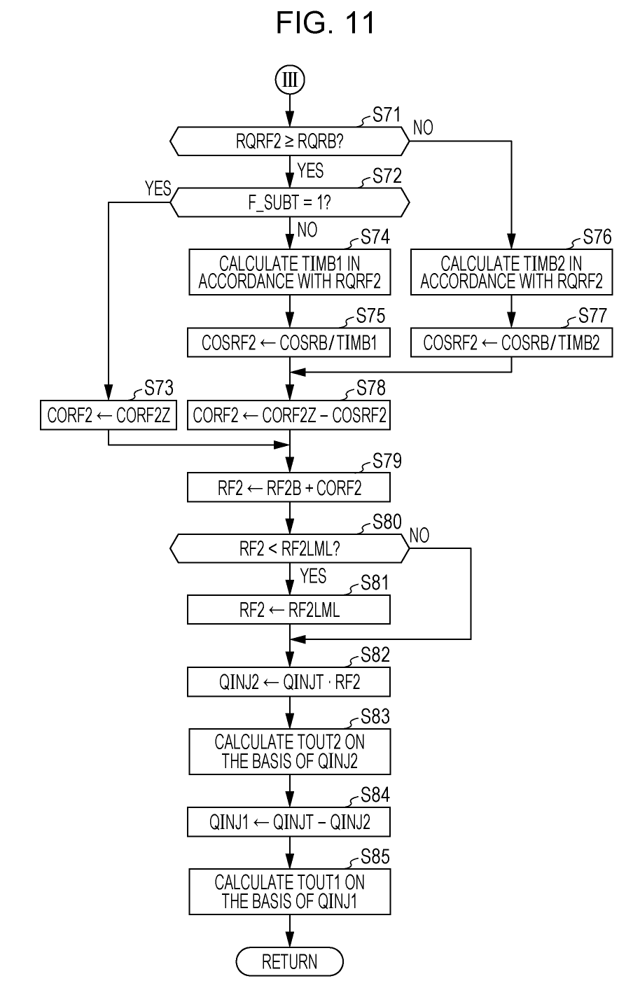

That is, first, retrieval is made from a predetermined map (not shown) in accordance with the first and second estimated ethanol concentrations EL1E and EL2E, and hence the stoichiometric mixture ratio of the gasoline G and the ethanol E is calculated. Then, the sum of a value obtained by multiplying a value, which is obtained by subtracting the basic port injection ratio RF2B calculated in aforementioned step 6 from the value 1.0, by the calculated stoichiometric mixture ratio of the gasoline G, and a value obtained by multiplying the basic port injection ratio RF2B by the calculated stoichiometric mixture ratio of the ethanol E, is calculated as a stoichiometric mixture ratio correction coefficient. The total fuel injection quantity QINJT is calculated in accordance with the stoichiometric mixture ratio correction coefficient. Hence, as the first and second estimated ethanol concentrations EL1E and EL2E are larger, the total fuel injection quantity QINJT is calculated at a larger value. Also, the aforementioned air fuel ratio correction coefficient is calculated in accordance with a predetermined feedback control algorithm so that the detected air fuel ratio LAF meets a predetermined target air fuel ratio. The stoichiometric mixture ratio correction coefficient may be calculated in accordance with the port injection ratio RF2 finally calculated in step 23 or 27 in FIG. 7, step 42 in FIG. 9, or step 79 or 81 in FIG. 11, instead of the basic port injection ratio RF2B.

In step 8 subsequent to aforementioned step 7, retrieval is made from a predetermined map (not shown) in accordance with the engine speed NE and the intake air quantity QAIR, and hence a basic ignition timing IGB is calculated. Then, the calculated basic ignition timing IGB is multiplied by a correction coefficient KIG, and hence a temporary ignition timing IGTEM is calculated (step 9). The correction coefficient KIG is calculated on the basis of, for example, the detected engine water temperature TW. In this way, the temporary ignition timing IGTEM is set at the optimum ignition timing of the ignition plug 8 such that the efficiency of the engine 3 is the highest.

Then, it is judged whether or not the detected knock intensity KNOCK is larger than a predetermined judgment value KJUD (step 10). It is to be noted that, in any of this processing and subsequent processing, the maximum value of KNOCK detected in a previous combustion cycle of the engine 3 is used as the knock intensity KNOCK instead of currently detected KNOCK.

If the answer in aforementioned step 10 is YES (KNOCK>KJUD), it is judged that knocking of the engine 3 is generated, knocking control processing is executed (step 11), and this processing is ended. In contrast, if the answer in step 10 is NO (KNOCK≦KJID), it is judged that knocking of the engine 3 is not generated, non-knocking control processing is executed (step 12), and this processing is ended.

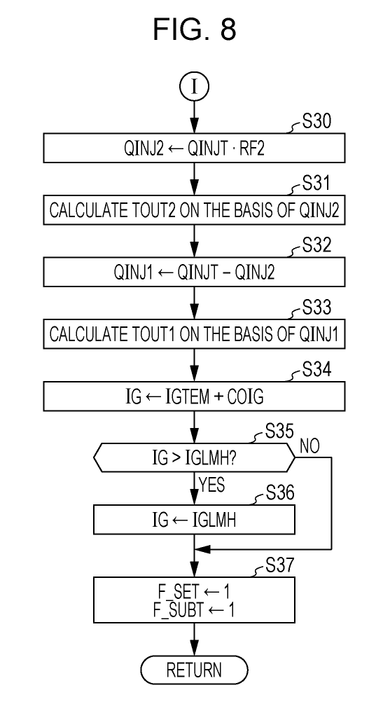

Next, the knocking control processing executed in step 11 in FIG. 6 is described with reference to FIGS. 7 and 8. First, in step 21 in FIG. 7, retrieval is made from a predetermined map (not shown) in accordance with the ethanol remaining quantity ratio RQRF2 calculated in step 1 in FIG. 6, the knock intensity KNOCK, the engine speed NE, and the intake air quantity QAIR, and hence an addition term COARF2 is calculated. In this map, the addition term COARF2 is set at a positive value, and the details of the setting will be described later.

Then, the addition term COARF2 calculated in step 21 is added to a previous value CORF2Z of a port injection ratio correction term being a correction term of the aforementioned basic port injection ratio RF2B, and hence a current port injection ratio correction term CORF2 is calculated (step 22). The previous value CORF2Z of the port injection ratio correction term is set at a predetermined upper limit value at start of the engine 3. Then, the port injection ratio correction term CORF2 calculated in step 22 is added to the basic port injection ratio RF2B calculated in step 6 in FIG. 6, and hence a port injection ratio RF2 is calculated (step 23).

Then, it is judged whether or not the calculated port injection ratio RF2 is larger than a predetermined upper limit value RF2LMH (step 24). The upper limit value RF2LMH is set at a positive value being the value 1.0 or smaller. If the answer in step 24 is NO (RF2≦RF2LMH), retrieval is made from a predetermined map (not shown) in accordance with the ethanol remaining quantity ratio RQRE2, and hence a first ignition timing correction term COIG1 is calculated (step 25). In this map, the first ignition timing correction term COIG1 is set at a positive value, and the details of the setting will be described later. Then, the calculated first ignition timing correction term COIG1 is set as an ignition timing correction term COIG (step 26), and the processing goes to step 30. The ignition timing correction term COIG is a correction term for correcting the temporary ignition timing IGTEM.

In contrast, if the answer in aforementioned step 24 is YES, and the port injection ratio RF2 is larger than the upper limit value RF2LMH, the port injection ratio RF2 is set at the upper limit value RF2LMH (step 27). Then, retrieval is made from a predetermined map (not shown) in accordance with the ethanol remaining quantity ratio RQRF2, and hence a second ignition timing correction term COIG2 is calculated (step 28). In this map, the second ignition timing correction term COIG2 is set at a positive value, and the details of the setting will be described later. Then, the calculated second ignition timing correction term COIG2 is set as the ignition timing correction term COIG (step 29), and the processing goes to step 30.

In step 30 in FIG. 8 subsequent to aforementioned step 26 or 29, the total fuel injection quantity QINJT calculated in step 7 in FIG. 6 is multiplied by the port injection ratio RF2 calculated in aforementioned step 23, and hence a target port injection quantity QINJ2 is calculated. Then, final port injection time TOUT2 being a target value of the valve open period of the port injection valve 7 is calculated on the basis of the calculated target port injection quantity QINJ2 (step 31). In this way, when the final port injection time TOUT2 is calculated, the port injection valve 7 is opened at a port injection start timing calculated by processing (not shown), and is controlled so that the valve open period meets the final port injection time TOUT2. Consequently, the port injection quantity is controlled to meet the target port injection quantity QINJ2 calculated in step 30.

Then, the target port injection quantity QINJ2 calculated in aforementioned step 30 is subtracted from the total fuel injection quantity QINJT, and hence a target in-cylinder injection quantity QINJ1 is calculated (step 32). Also, final in-cylinder injection time TOUT1 being a target value of the valve open period of the in-cylinder injection valve 6 is calculated on the basis of the calculated target in-cylinder injection quantity QINJ1 (step 33). In this way, when the final in-cylinder injection time TOUT1 is calculated, the in-cylinder injection valve 6 is opened at an in-cylinder injection start timing calculated by processing (not shown), and is controlled so that the valve open period meets the final in-cylinder injection time TOUT1. Consequently, the in-cylinder injection quantity is controlled to meet the target in-cylinder injection quantity QINJ1 calculated in step 32.

In step 34 subsequent to aforementioned step 33, the ignition timing correction term COIG calculated in step 26 or 29 is added to the temporary ignition timing IGTEM calculated in step 9 in FIG. 6, and hence an ignition timing IG is calculated. Then, it is judged whether or not the calculated ignition timing IG is larger than a predetermined upper limit value IGLMH (step 35). The upper limit value IGLMH is a limit value at the retard side of the ignition timing IG. If the answer in step 35 is YES (IG>IGLMH), the ignition timing IG is set at an upper limit value IGLMH (step 36), and the processing goes to step 37. In contrast, if the answer is NO (IG≦IGLMH), the processing skips step 36 and goes to step 37.

In step 37, a setting flag F_SET and a subtraction flag FSUBT (described later) are set at “1,” and this processing is ended. When the ignition timing IG is calculated in this way, the ignition timing of the ignition plug 8 is controlled to meet the calculated ignition timing IG. As the value of the ignition timing IG is larger, the ignition timing IG is at the further retard side. Also, the setting flag F_SET and the subtraction flag FSUBT are reset at “0” at start of the engine 3.

As described above, in the knocking control processing, by adding the port injection ratio correction term CORF2 to the basic port injection ratio RF2B by execution of aforementioned steps 21 to 23, the port injection ratio RF2 is corrected to be increased. In this case, the addition term COARF2 to be added to the port injection ratio correction term CORF2 is set at a larger value as the ethanol remaining quantity ratio RQRF2 is larger, and is set at a larger vale as the knock intensity KNOCK is larger in the map. Accordingly, the increase correction amount of the port injection ratio RF2 is increased as the ethanol remaining quantity ratio RQRF2 is larger and the knock intensity KNOCK is larger. The port injection ratio correction term CORF2 is limited to the upper limit value or smaller by limit processing (not shown).

Also, in the knocking control processing, the ignition timing IG is corrected to the retard side by adding the ignition timing correction term COIG to the basic ignition timing IGB by execution of aforementioned steps 25, 26, 28, 29, and 34. In this case, the first and second ignition timing correction terms COIG1 and COIG2 each used as the ignition timing correction term COIG are set at larger values as the ethanol remaining quantity ratio RQRF2 is smaller in the map. Accordingly, the retard correction amount of the ignition timing IG is increased as the ethanol remaining quantity ratio RQRF2 is smaller. Also, the first and second ignition timing correction terms COIG1 and COIG2 are set at values that can restrict knocking of the engine 3 in accordance with the influence of adhesion of the ethanol E to the wall surface of the intake air port 4a, and the influence of a time delay until the fuel injected from the port injection valve 7 actually flows into the cylinder 3a (hereinafter, referred to as “inflow time delay of port injection fuel”).

Also, the port injection ratio RF2 corrected to be increased is limited to the upper limit value RF2LMH or smaller (step 24, step 27). Further, when the port injection ratio RF2 is limited to the upper limit value RF2LMH (step 24: YES), the second ignition timing correction term COIG2 is used as the ignition timing correction term COIG. In the case without the limitation (step 24: NO), the first ignition timing correction term COIG1 is used as the ignition timing correction term COIG. In the map, the second ignition timing correction term COIG2 is set at a larger value than the first ignition timing correction term COIG1 for the entire ethanol remaining quantity ratio RQRF2. Accordingly, when the port injection ratio RF2 corrected to be increased is limited to the upper limit value RF2LMH, the retard correction amount of the ignition timing IG is larger than that in the case without the limitation.

Next, the non-knocking control processing executed in step 12 in FIG. 6 is described with reference to FIGS. 9 to 11. First, in step 41 in FIG. 9, it is judged whether or not the intake air quantity QAIR is larger than a predetermined value QKNOCK. If the answer is NO (QAIR≦QKNOCK), it is judged that the engine 3 is not in a load region in which knocking may be generated. Then, the basic port injection ratio RF2B calculated in step 6 in FIG. 6 is set as the port injection ratio RF2 without change (step 42).

Then, in steps 43 to 46, the target port injection quantity QINJ2, final port injection time TOUT2, target in-cylinder injection quantity QINJ1, and final in-cylinder injection time TOUT1 are respectively calculated similarly to steps 30 to 33 in FIG. 8. In this way, the port injection quantity is controlled to meet the target port injection quantity QINJ2 calculated in step 43, and the in-cylinder injection quantity is controlled to meet the target in-cylinder injection quantity QINJ1 calculated in step 45.

Then, the ignition timing IG is set at the temporary ignition timing IGTEM calculated in step 9 in FIG. 6 (step 47), and this processing is ended. When the ignition timing IG is calculated in this way, the ignition timing of the ignition plug 8 is controlled to meet the ignition timing IG calculated in step 47, similarly to step 34.

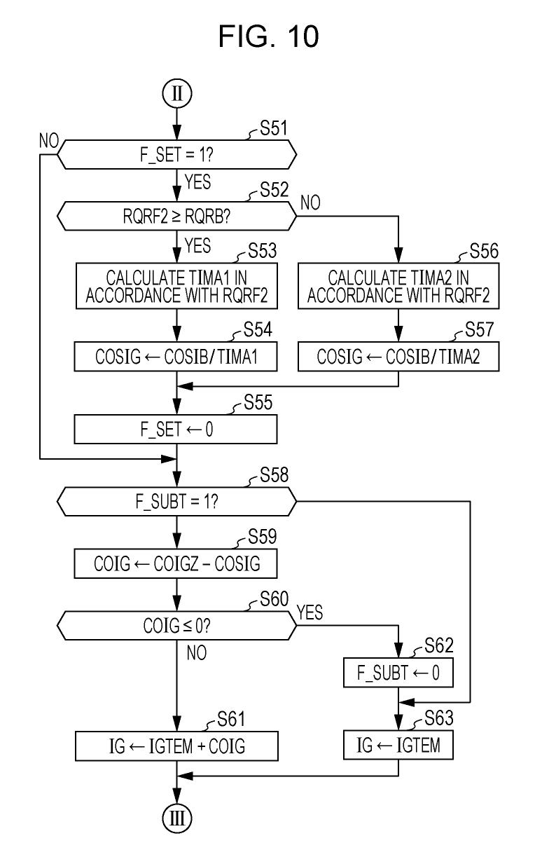

In contrast, if the answer in aforementioned step 41 is YES (QAIR>QKNOCK), it is judged that the engine 3 is in the load region in which knocking may be generated. Then, in step 51 in FIG. 10, it is judged whether or not the setting flag F_SET is “1.” If the answer is YES (F_SET=1), it is judged whether or not the ethanol remaining quantity ratio RQRF2 is a predetermined value RQRB or larger (step 52).

If the answer in step 52 is YES (RQRF2≧RQRB), retrieval is made from a predetermined map (not shown) in accordance with the ethanol remaining quantity ratio RQRF2, and hence a first subtraction time TIMA1 is calculated (step 53). In this map, the first subtraction time TIMA1 is set at a positive value, and the details of the setting will be described later. Then, a predetermined basic subtraction term COSIB is divided by the calculated first subtraction time TIMA1, and hence a subtraction term COSIG is calculated (step 54). Then, to end the calculation and setting of the subtraction term COSIG, the setting flag F_SET is reset at “0” (step 55), and the processing goes to step 58.

In contrast, if the answer in step 52 is NO, and the ethanol remaining quantity ratio RQRF2 is smaller than the predetermined value RQRB, retrieval is made from a predetermined map (not shown), and hence a second subtraction time TIMA2 is calculated (step 56). In this map, the second subtraction time TIMA2 is set at a positive value, and the details of the setting will be described later. Then, the above-described basic subtraction term COSIB is divided by the calculated second subtraction time TIMA2, and hence a subtraction term COSIG is calculated (step 57). Then, to end the calculation and setting of the subtraction term GOSIG, aforementioned step 55 is executed (F_SET≦0), and the processing goes to step 58.

In contrast, if the answer in aforementioned step 51 is NO (F_SET=0), the processing skips steps 52 to 57 and goes to step 58.

In step 58, it is judged whether or not the subtraction flag F_SUBT is “1.” If the answer is YES (F_SUBT=1), the subtraction term COSIG calculated in step 54 or 57 is subtracted from a previous value COIGZ of the ignition timing correction term set in step 26 or 29 in FIG. 7, and hence a current ignition timing correction term COIG is calculated (step 59).

Then, it is judged whether or not the ignition timing correction term COIG calculated in step 59 is the value 0 or smaller (step 60). If the answer is NO (COIG>0), the ignition timing correction term COIG calculated in step 59 is added to the temporary ignition timing IGTEM calculated in step 9 in FIG. 6, hence an ignition timing IG is calculated (step 61), and the processing goes to step 71 in FIG. 11. When the ignition timing IG is calculated in this way, the ignition timing of the ignition plug 8 is controlled to meet the ignition timing IG calculated in step 61 similarly to, for example, step 34 in FIG. 8.

In contrast, if the answer in aforementioned step 60 is YES and the ignition timing correction term COIG is the value 0 or smaller, to end the subtraction processing of the ignition timing correction term COIG in step 59, the subtraction flag FSUBT is reset at “0” (step 62). Then, the ignition timing IG is set at the temporary ignition timing IGTEM calculated in step 9 in FIG. 6 (step 63), and the processing goes to step 71 in FIG. 11.

In contrast, if the answer in aforementioned step 58 is NO (F_SUBT=0), aforementioned step 63 is executed, hence the ignition timing IG is set at the temporary ignition timing IGTEM, and the processing goes to step 71 in FIG. 11.

In step 71 in FIG. 11 subsequent to step 61 or 63 in FIG. 10, it is judged whether or not the ethanol remaining quantity ratio RQRF2 is a predetermined value RQRB or larger. If the answer is YES (RQRF2≧RQRB), it is judged whether or not the subtraction flag F_SUBT is “1” (step 72). If the answer is YES (F_SUBT=1), that is, if the situation is during execution of the subtraction processing of the ignition timing correction term COIG in aforementioned step 59, the previous value CORF2Z of the port injection ratio correction term is set as a current port injection ratio correction term CORF2 (step 73), and the processing goes to step 79 (described later).

In contrast, if the answer in aforementioned step 72 is NO (F_SUBT=0) and the situation is not during execution of the subtraction processing of the ignition timing correction term COIG, retrieval is made from a predetermined map (not shown) in accordance with the ethanol remaining quantity ratio RQRF2, and hence first subtraction time TIMB1 is calculated (step 74). In this map, the first subtraction time TIMB1 is set at a positive value, and the details of the setting will be described later. Then, a predetermined basic subtraction term COSRB is divided by the calculated first subtraction time TIMB1, hence a subtraction term COSRF2 is calculated (step 75), and the processing goes to step 78.

In contrast, if the answer in aforementioned step 71 is NO (RQRF2<RQRB), retrieval is made from a predetermined map (not shown) in accordance with the ethanol remaining quantity ratio RQRF2, and hence second subtraction time TIMB2 is calculated (step 76). In this map, the second subtraction time TIMB2 is set at a positive value, and the details of the setting will be described later. Then, the aforementioned basic subtraction term COSRB is divided by the calculated second subtraction time TIMB2, hence a subtraction term COSRF2 is calculated (step 77), and the processing goes to step 78.

In step 78 subsequent to aforementioned step 75 or 77, the subtraction term COSRF2 calculated in step 75 or 77 is subtracted from the previous value CORF2Z of the port injection ratio correction term, and hence a current port injection ratio correction term CORF2 is calculated. Then, the processing goes to step 79.

In step 79 subsequent to aforementioned step 73 or 78, the port injection ratio correction term CORF2 set and calculated in step 73 or 78 is added to the basic port injection ratio RF2B calculated in step 6 in FIG. 6, and hence a port injection ratio RF2 is calculated. Then, it is judged whether or not the calculated port injection ratio RF2 is smaller than a predetermined lower limit value RF2LML (step 80). The lower limit value RF2LML is set at a smaller positive value than the upper limit value RF2LMH used in step 24 in FIG. 7.

If the answer in step 80 is YES (RF2<RF2LML), the port injection ratio RF2 is set at the lower limit value RF2LML (step 81), and the processing goes to step 82. In contrast, if the answer in step 80 is NO and the port injection ratio RF2 is the lower limit value RF2LML or larger, the processing skips step 81 and goes to step 82.

In subsequent steps 82 to 85, the target port injection quantity QINJ2, final port injection time TOUT2, target in-cylinder injection quantity QINJ1, and final in-cylinder injection time TOUT1 are respectively calculated similarly to steps 30 to 33 in FIG. 8, and this processing is ended. In this way, the port injection quantity is controlled to meet the target port injection quantity QINJ2 calculated in step 82, and the in-cylinder injection quantity is controlled to meet the target in-cylinder injection quantity QINJ1 calculated in step 84.

As described above, in the non-knocking control processing, if the engine 3 is not in the load region in which knocking may be generated (step 41: NO in FIG. 9), the port injection ratio RF2 is set at the basic port injection ratio RF2B (step 42), and the ignition timing IG is set at the temporary ignition timing IGTEM (step 47). Also, if the engine 3 is in the load region in which knocking may be generated (step 41: YES), the subtraction flag F_SUBT is held at “0” unless knocking is generated from start of the engine 3, and hence the ignition timing IG is set at the temporary ignition timing IGTEM (step 58: NO, step 63 in FIG. 10).

In contrast, in the case where the engine 3 is in the load region in which knocking may be generated, when generation of knocking of the engine 3 has been judged and hence the knocking control processing has been executed, the subtraction processing of subtracting the ignition timing correction term COIG set in the knocking control processing is executed (step 59 in FIG. 10).

The subtraction processing of the ignition timing correction term COIG is repeated until the ignition timing correction term COIG becomes the value 0 or smaller. In the execution, the ignition timing IG is set at a value obtained by adding the ignition timing correction term COIG to the temporary ignition timing IGTEM (step 61 in FIG. 10). Then, if the ignition timing correction term COIG becomes the value 0 or smaller (step 60: YES), the subtraction processing of the ignition timing correction term COIG is ended, and the subtraction flag F_SUET is set at “0” (step 62). When the subtraction processing of the ignition timing correction term COIG has been ended and later, the ignition timing IG is set at the temporary ignition timing IGTEM (step 58: NO, step 63). In this way, the ignition timing IG is corrected to the retard side with respect to the temporary ignition timing IGTEM at generation of knocking of the engine 3, and when knocking is no longer generated, the ignition timing IG is gradually restored to the temporary ignition timing IGTEM at the advance side.

Further, the subtraction term COSIG to be subtracted from the ignition timing correction term COIG is calculated by dividing the predetermined basic subtraction term COSIB by the first or second subtraction time TIMA1 or TIMA2 (step 54, step 57 in FIG. 10). The first and second subtraction times TIMA1 and TIMA2 are set at larger values as the ethanol remaining quantity ratio RQRF2 is smaller (step 53, step 56). Also, if the ethanol remaining quantity ratio RQRF2 is the predetermined value RQRB or larger (step 52: YES), the first subtraction time TIMA1 is used, and if the ethanol remaining quantity ratio RQRF2 is smaller than the predetermined value RQRB (step 52: NO), the second subtraction time TIMA2 is used. The second subtraction time TIMA2 is set at a larger value than the first subtraction time TIMA1 for the entire ethanol remaining quantity ratio RQRF2. In this way, as the ethanol remaining quantity ratio RQRF2 is smaller, the subtraction term COSIG is set at a smaller value, and hence the time required for the ignition timing IG to be restored to the temporary ignition timing IGTEM is longer.

Further, the first subtraction time TIMA1 is set in accordance with the inflow time delay of the port injection fuel in the map (a time delay until the fuel injected from the port injection valve 7 actually flows into the cylinder 3a). During the inflow time delay of the port injection fuel, the ignition timing correction term COIG is set at a value so as not to be the value 0.

Also, in the non-knocking control processing, when the engine 3 is in the load region in which knocking may be generated, the subtraction processing of the port injection ratio correction term CORF2 of subtracting the port injection ratio correction term CORF2 is executed (step 78 in FIG. 11). The subtraction processing of the port injection ratio correction term CORF2 is basically repeatedly executed unless knocking of the engine 3 is not generated and the engine 3 is in the load region in which knocking may be generated, unlike the above-described subtraction processing of the ignition timing correction term COIG.

In contrast, when knocking of the engine 3 is no longer generated, if the ethanol remaining quantity ratio RQRF2 is the predetermined value RQRB or larger (step 71: YES), the subtraction processing of the port injection ratio correction term CORF2 is not executed from the start of the non-knocking control processing to the end of the subtraction processing of the ignition timing correction term COIG, and the port injection ratio correction term CORF2 is held at the previous value CORF2Z (step 72: YES, step 73). Accordingly, the port injection ratio correction term CORF2 is held at the value increased by the knocking control processing (step 22 in FIG. 7) from the start of the non-knocking control processing until the ignition timing correction term COIG becomes the value 0. Then, when the subtraction processing of the ignition timing correction term COIG is ended (step 72: NO), the subtraction processing of the port injection ratio correction term CORF2 is started.

In contrast, if the ethanol remaining quantity ratio RQRF2 is smaller than the predetermined value RQRB (step 71: NO), the subtraction processing of the port injection ratio correction term CORF2 is started along with the start of the non-knocking control processing regardless of the subtraction processing of the ignition timing correction term COIG. That is, in this case, the subtraction processing of the ignition timing correction term COIG and the subtraction processing of the port injection ratio correction term CORF2 are executed in parallel to one another.

Also, the subtraction term COSRF2 subtracted from the port injection ratio correction term CORF2 is calculated by dividing the predetermined basic subtraction term COSRB by first or second subtraction time TIMB1 or TIMB2 (step 75, step 77 in FIG. 11). The first and second subtraction times TIMB1 and TIMB2 are set at smaller values as the ethanol remaining quantity ratio RQRF2 is smaller (step 74, step 76). Also, if the ethanol remaining quantity ratio RQRF2 is the predetermined value RQRB or larger (step 71: YES), the first subtraction time TIMB1 is used, and if the ethanol remaining quantity ratio RQRF2 is smaller than the predetermined value RQRB (step 71: NO), the second subtraction time TIMB2 is used. The second subtraction time TIMB2 is set at a smaller value than the first subtraction time TIMB1 for the entire ethanol remaining quantity ratio RQRF2. In this way, since the subtraction term COSRF2 is set at a larger value as the ethanol remaining quantity ratio RQRF2 is smaller, the port injection ratio correction term CORF2 is decreased at a larger gradient. Consequently, the port injection ratio RF2, to which the port injection ratio correction term CORF2 is added, is decreased at a larger gradient.

It is to be noted that the port injection ratio correction term CORF2 is limited to the predetermined lower limit value or larger by limit processing (not shown).

As described above, in the engine control processing, the port injection ratio RF2 is basically corrected to be decreased when knocking of the engine 3 is not generated, and is basically corrected to be increased when knocking of the engine 3 is generated by the following reasons. The accuracies of the first and second ethanol concentrations EL1 and EL2 detected by the first and second concentration sensors 39 and 40 are not so high because of the influence by individual variations between both the sensors 39 and 40 and deterioration over time of the sensors 39 and 40. Hence, although the port injection ratio RF2 is calculated by using the first and second estimated ethanol concentrations EL1E and EL2E calculated on the basis of the first and second ethanol concentrations EL1 and EL2 and by using the request ethanol concentration EREQ, the actual ethanol concentration of the fuel to be supplied into the combustion chamber 3d may be higher or lower than the request ethanol concentration EREQ. The former case may result in waste consumption of the ethanol E, and the latter case may result in frequent generation of knocking of the engine 3. With regard to this, knocking of the engine 3 is restricted while the consumption of the ethanol E is minimized.

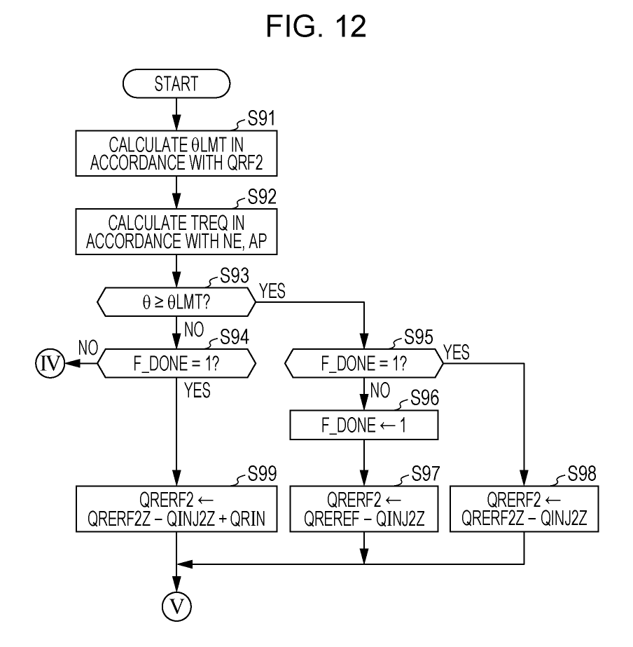

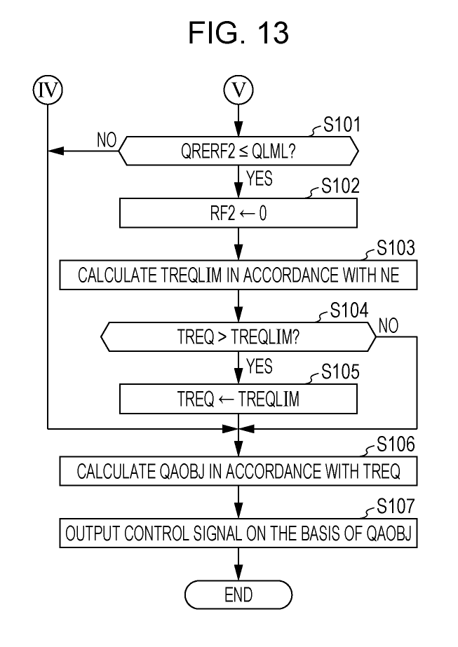

Next, processing for controlling the intake air quantity QAIR of the engine 3 is described with reference to FIGS. 12 and 13. This processing is repeatedly executed in synchronization with generation of the TDC signal and in parallel to the engine control processing. First, overview of this processing is described. As described above with reference to FIGS. 4A to 4C, the ethanol E in the tank main body 22b cannot be introduced into the reservoir 22c depending on the relationship between the main body ethanol remaining quantity QRF2 (the remaining quantity of the ethanol E in the tank main body 22b) and the second fuel tank inclination angle θ, and hence only the ethanol E in the reservoir 22c can be sucked with the low pressure pump 22a. In the processing shown in FIGS. 12 and 13, in such a case, the intake air quantity QAIR is controlled to limit the output of the engine 3 for restricting knocking of the engine 3 when the ethanol E in the reservoir 22c reaches a lower limit value QLML (described later).

First, in step 91 in FIG. 12, retrieval is made from a predetermined map (not shown) in accordance with the main body ethanol remaining quantity QRF2, and hence an upper limit inclination angle θLMT is calculated. The upper limit inclination angle θLMT corresponds to the minimum value of the second fuel tank inclination angle θ when the reservoir intake port 22e of the intake passage 22d is positioned above the liquid level of the ethanol E in the tank main body 22b and is not immersed in the ethanol E. In the above-described map, the upper limit inclination angle θLMT is set at a larger value as the main body ethanol remaining quantity QRF2 is larger on the basis of the positional relationship between the liquid level of the ethanol E in the tank main body 22b and the reservoir intake port 22e described with reference to FIGS. 4A to 4C.

Then, retrieval is made from a predetermined map (not shown) in accordance with the engine speed NE and the detected accelerator opening degree AP, and hence a request torque TREQ of the engine 3 is calculated (step 92). In this map, the request torque TREQ is set at a larger value as the accelerator opening degree AP is larger. Then, it is judged whether or not the detected second fuel tank inclination angle θ is the upper limit inclination angle θLMT calculated in aforementioned step 91 or larger (step 93).

If the answer in step 93 is NO (θ<θLMT), that is, when the reservoir intake port 22e is positioned below the liquid level of the ethanol E in the tank main body 22b and is immersed in the ethanol E, it is judged whether or not an inclination done flag F_DONE is “1” (step 94). The inclination done flag F_DONE is set at “1” if the answer in step 93 is YES after start of the engine 3, and is reset at “0” at start of the engine 3.

If the answer in aforementioned step 94 is NO (F_DONE=0), that is, if the reservoir intake port 22e is continuously positioned below the liquid level of the ethanol E in the tank main body 22b and is immersed in the ethanol E from start of the engine 3 to the current time, the processing goes to step 106 in FIG. 13 (described later).

In contrast, if the answer in aforementioned step 93 is YES (θ≧θLMT), that is, if the reservoir intake port 22e is positioned above the liquid level of the ethanol E in the tank main body 22b, it is judged whether or not the inclination done flag F_DONE is “1” (step 95).

If the answer in step 95 is NO (F_DONE=0), the inclination done flag F_DONE is set at “1” to express that the answer in step 93 becomes YES, that is, the reservoir intake port 22e is positioned above the liquid level of the ethanol E in the tank main body 22b after start of the engine 3 (step 96). Then, the previous value QINJ2Z of the target port injection quantity calculated in FIG. 8, FIG. 9, FIG. 11, etc., if subtracted from a predetermined value QREREF, hence a remaining quantity QRERF2 of the ethanol E in the reservoir 22c (hereinafter, referred to as “reservoir ethanol remaining quantity”) is calculated (step 97), and the processing goes to step 101 in FIG. 13. The predetermined value QREREF corresponds to the reservoir ethanol remaining quantity at previous execution of this processing and before execution of injection of the ethanol E by the port injection valve 7. For example, the predetermined value QREREF is calculated by making retrieval from a predetermined map (not shown) in accordance with the main body ethanol remaining quantity QRF2 previously detected. In this map, the predetermined value QREREF is set at a larger value as QRF2 is larger.

In contrast, if the answer in aforementioned step 95 is YES (F_DONE=1), the previous value QINJ2Z of the target port injection quantity is subtracted from the previous value QRERF2Z of the reservoir ethanol remaining quantity, and hence a current reservoir ethanol remaining quantity QRERF2 is calculated (step 98), and the processing goes to step 101 in FIG. 13.

In contrast, if the answer in aforementioned step 94 is YES (F_DONE=1), that is, if the answer in step 93 is once YES and then becomes NO, an ethanol inflow quantity QRIN is added to the value obtained by subtracting the previous QINJ2Z of the target port injection quantity from the previous value QRERF2Z of the reservoir ethanol remaining quantity, hence a reservoir ethanol remaining quantity QRERF2 is calculated (step 99), and the processing goes to step 101 in FIG. 13. The ethanol inflow quantity QRIN is the inflow quantity of the ethanol E flowing from the inside of the tank main body 22b into the reservoir 22c from the previous processing timing to the current processing timing of this processing. For example, the ethanol inflow quantity QRIN is calculated by map retrieval in accordance with the main body ethanol remaining quantity QRF2. The ethanol inflow quantity QRIN is basically larger than the previous value QINJ2Z of the target port injection quantity. Although not shown, in step 99, the reservoir ethanol remaining quantity QRERF2 is limited to the maximum value or smaller of the ethanol E that can be stored in the reservoir 22c.

In step 101 in FIG. 13 subsequent to aforementioned step 97, 98, or 99, it is judged whether or not the calculated reservoir ethanol remaining quantity QRERF2 is a predetermined lower limit value QLML or smaller. The lower limit value QLML is set at a value with predetermined hysteresis to prevent the answer in step 101 from being frequently switched between YES and NO on the basis of the reservoir ethanol remaining quantity QRERF2 calculated as described above. For example, the lower limit value QLML is set at the value 0 when the reservoir ethanol remaining quantity QRERF2 is calculated in step 97 or 98, and is set at a value slightly larger than the value 0 when the reservoir ethanol remaining quantity QRERF2 is calculated in step 99.

If the answer in step 101 is NO (QRERF2>QLML), the processing goes to step 106. In contrast, if the answer in step 101 is YES and the reservoir ethanol remaining quantity QRERF2 is the lower limit value QLML or smaller, the port injection ratio RF2 is set at the value 0 (step 102). When step 102 is executed, the port injection ratio RF2 set at the value 0 accordingly is used with high priority for calculation of the target port injection quantity QINJ2 in step 30 in FIG. 8, step 43 in FIG. 9, and step 82 in FIG. 11 although it is not illustrated in FIGS. 8, 9, and 11. Accordingly, since the target port injection quantity QINJ2 is calculated at the value 0, the injection operation of the ethanol E by the port injection valve 7 is stopped, and the gasoline G by the total fuel injection quantity QINJT is injected from the in-cylinder injection valve 6.

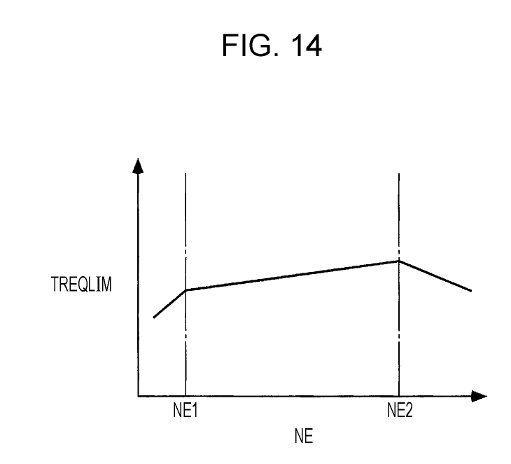

In step 103 subsequent to step 102, retrieval is made from a map shown in FIG. 14 in accordance with the engine speed NE, and hence an upper limit request torque TREQLIM is calculated. The upper limit request torque TREQLIM is an upper limit value of the request torque TREQ of the engine 3. In the map shown in FIG. 14, the upper limit request torque TREQLIM is set at the maximum torque value that reliably restricts knocking of the engine 3 when the port injection ratio RF2 is set at the value 0, that is, when only the gasoline G is supplied to the combustion chamber 3d. Also, as shown in FIG. 14, the upper limit request torque TREQLIM is set at a larger value with a relatively large gradient as NE is higher in an extremely low rotation region in which the engine speed NE is lower than a predetermined first speed NE1; is set at a larger value with a relatively small gradient as NE is higher in a low to high rotation region in which NE is NE1 or higher and lower than a predetermined second speed NE2 (>NE1); and is set at a smaller value with a relatively large gradient as NE is higher in a high rotation region in which NE is NE2 or higher. Such setting of the upper limit request torque TREQLIM is based on the relationship between the engine speed NE and the output torque of the engine 3. This is similar to the relationship between the number of rotations of a typical internal-combustion engine and the output torque.

In step 104 subsequent to aforementioned step 103, it is judged whether or not the request torque TREQ calculated in step 92 in FIG. 12 is larger than the upper limit request torque TREQLIM calculated in step 103. If the answer is YES (TREQ>TREQLIM), the request torque TREQ is set at the upper limit request torque TREQLIM (step 105), and the processing goes to step 106. In contrast, if the answer is NO (TREQ 5≦TREQLIM) in step 104, the processing skips step 105 and goes to step 106.

In step 106 to be executed subsequently to the answer NO in step 94 in FIG. 12 (θ<θGLMT and F_DONE=0), the answer NO in aforementioned step 101 (QRERF2>QLML), the answer NO in step 104 (TREQ≦TREQLIM), or step 105, retrieval is made from a predetermined map (not shown) in accordance with the request torque TREQ calculated and set in step 92 in FIG. 12, or step 105 in FIG. 13, and hence a target intake air quantity QAOBJ is calculated. In this map, the target intake air quantity QAOBJ is set at a larger value as the request torque TREQ is larger.

Then, a control signal based on the calculated target intake air quantity QAOBJ is output to the TH actuator 9b (step 107), and this processing is ended. By executing step 107, the opening degree of the throttle valve 9 is controlled, hence the intake air quantity QAIR is controlled to meet the target intake air quantity QAOBJ, and the torque of the engine 3 is controlled to meet the request torque TREQ.

As described above, with the processing shown in FIG. 12 and FIG. 13, when the second fuel tank inclination angle θ has never reached the upper limit inclination angle θLMT (step 94: NO in FIG. 12) after start of the engine 3, the request torque TREQ calculated in accordance with the engine speed NE etc. is directly used for control of the intake air quantity QAIR (step 92, steps 106 and 107 in FIG. 13). Then, if the second fuel tank inclination angle θ becomes the upper limit inclination angle θLMT or larger (step 93: YES), the reservoir ethanol remaining quantity QRERF2 being the remaining quantity of the ethanol E in the reservoir 22c is calculated.

In this case, when the second fuel tank inclination angle θ first becomes the upper limit inclination angle θLMT or larger after start of the engine 3 (step 95: NO), a reservoir ethanol remaining quantity QRERF2 is calculated by subtracting the previous value QINJ2Z of the target port injection quantity from the predetermined value QREREF corresponding to the reservoir ethanol remaining quantity before injection of the ethanol E is executed by the port injection valve 7 at the previous time (step 97). Then, as long as θ is θLMT or larger (step 95: YES), a reservoir ethanol remaining quantity QRERF2 is calculated by subtracting the previous value QINJ2Z of the target port injection quantity from the previous value QRERF2Z of the reservoir ethanol remaining quantity (step 98).

The reservoir ethanol remaining quantity QRERF2 is calculated as described above if the second fuel tank inclination angle θ is the upper limit inclination angle θLMT or larger, because, if θ≧θLMT, the reservoir intake port 22e is positioned above the liquid level of the ethanol E in the tank main body 22b and hence the ethanol E in the tank main body 22b is not sucked into the reservoir 22c, and because the ethanol E in the reservoir 22c is consumed by the port injection quantity (the target port injection quantity QINJ2).

If the second fuel tank inclination angle θ becomes smaller than θLMT (step 93: NO, step 94: YES), a reservoir ethanol remaining quantity QRERF2 is calculated by adding the ethanol inflow quantity QRIN to the value obtained by subtracting the previous value QINJ2Z of the target port injection quantity from the previous value QRERF2Z of the reservoir ethanol remaining quantity (step 99). The ethanol inflow quantity QRIN is an inflow quantity of the ethanol E flowing from the inside of the tank main body 22b into the reservoir 22c from the previous time to the current time of this processing as described above.

In this case, the reservoir ethanol remaining quantity QRERF2 is calculated as described above because the ethanol E in the reservoir 22c is still consumed by the port injection quantity, and in addition, if θ<θLMT, the reservoir intake port 22e is immersed in the ethanol E in the tank main body 22b and hence the ethanol E in the tank main body 22b flows into the reservoir 22c. Since the ethanol inflow quantity QRIN is basically larger than the port injection quantity as described above, the reservoir ethanol remaining quantity QRERF2 calculated in step 99 is increased along with repetitive execution of this processing.

Also, the correspondence between various elements according to the first embodiment and various elements according to this disclosure is as follows. The first and second fuel tanks 21 and 22 according to the first embodiment respectively correspond to a low octane fuel tank and a high octane fuel tank according to this disclosure, the inclination sensor 40 according to this embodiment corresponds to an inclination state acquiring unit according to this disclosure, and the ECU 2 according to this embodiment corresponds to a remaining quantity acquiring unit and an output limiting unit according to this disclosure.

As described above, with the first embodiment, the second fuel tank inclination angle θ being the inclination angle when the second fuel tank 22 is inclined rightward is detected by the inclination sensor 40, and the reservoir ethanol remaining quantity QRERF2 being the remaining quantity of the ethanol E in the reservoir 22c is calculated (steps 97 to 99 in FIG. 12). Also, the output of the engine 3 is controlled in accordance with the second fuel tank inclination angle θ and the reservoir ethanol remaining quantity QRERF2.

To be more specific, in the case where the second fuel tank inclination angle θ is the upper limit inclination angle θLMT or larger (step 93: YES in FIG. 12), when the reservoir ethanol remaining quantity QRERF2 reaches the lower limit value (step 101: YES in FIG. 13), the output (torque) of the engine 3 is limited to the level that can reliably restrict knocking even when only the gasoline G is supplied into the cylinder 3a (steps 103 to 107). Accordingly, when the ethanol E cannot be supplied into the cylinder 3a due to an inclination of the second fuel tank 22 and due to a decrease in the reservoir ethanol remaining quantity QRERF2, knocking of the engine 3 can be properly restricted. In this case, the upper limit request torque TREQLIM used for the limitation of the output of the engine 3 is set at the maximum torque value that reliably restricts knocking of the engine 3 when only the gasoline G is supplied into the cylinder 3a. Accordingly, the above-described advantageous effects can be attained without excessive limitation of the output of the engine 3.

Also, the output of the engine 3 is limited after the reservoir ethanol remaining quantity QRERF2 is actually decreased to the lower limit value QLML, in addition to the situation in which the second fuel tank 22 is inclined. Accordingly, the limitation can be prevented from being unnecessarily executed.

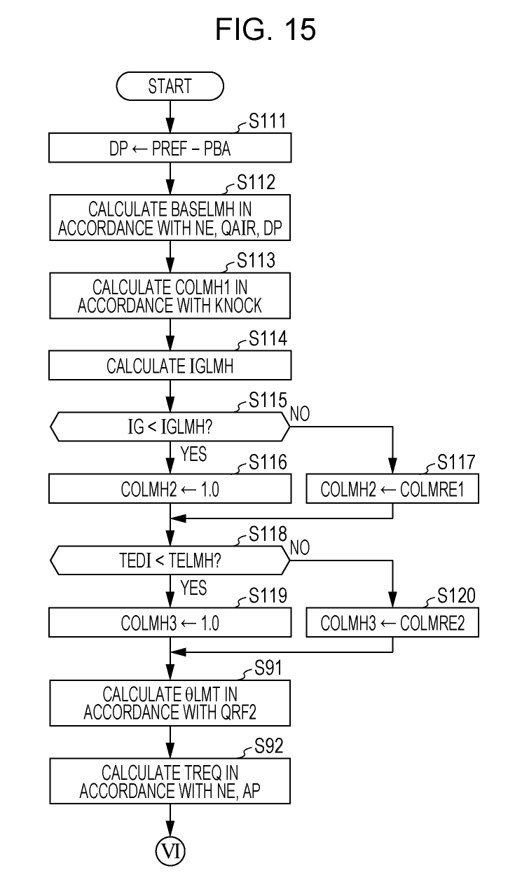

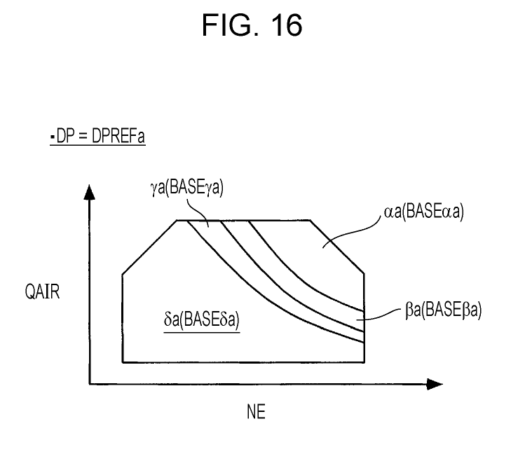

Next, a control device according to a second embodiment of this disclosure is described with reference to FIGS. 15 to 21. This control device differs from the first embodiment mainly for processing for controlling the intake air quantity QAIR. In the processing for controlling the intake air quantity QAIR according to the second embodiment as shown in FIG. 15 and other drawings, in the case where the second fuel tank inclination θ is at the upper limit inclination angle θLMT or larger, the request torque TREQ is gradually limited in accordance with a decrease in the reservoir ethanol remaining quantity QRERF2. In FIGS. 15, 17, and 19, the same step numbers are applied to portions having the same execution contents as those of the first embodiment. The points different from the first embodiment are mainly described below.

In step 111 in FIG. 15, an intake air pressure PBA is subtracted from a predetermined pressure PREF being a discharge pressure of the fuel by the above-described low pressure pump 22a, and hence a pressure deviation DP is calculated. Then, retrieval is made from a map shown in FIG. 16 in accordance with the engine speed NE, the intake air quantity QAIR, and the pressure deviation DP calculated in step 111, and hence a basic value BASELMH of the above-described upper limit value RF2LMH of the port injection ratio RF2 is calculated (step 112).

As the map for calculating the basic value BASELMH, four maps are set for cases of use where the pressure deviation DP is a first predetermined value DPREFa, a second predetermined value DPREFb, a third predetermined value DPREFc, and a fourth predetermined value DPREFd. FIG. 16 shows the map used for the case where DP is DPREFa. Also, the magnitude relationship among the first to fourth predetermined values DPREFa to DPREFd is set in the order of DPREFa>DPREFb>DPREFc>DPREFd.

Also, as shown in FIG. 16, in the map for calculating the basic value BASELMH, a plurality of regions αa, βa, γa, and δa determined by the engine speed NE and the intake air quantity QAIR are set. If NE and QAIR are provided in each of the regions αa, βa, γa, and δa, the basic value BASELMH is set for each of predetermined first, second, third, and fourth basic values BASEαa, BASEβa, BASEγa, and BASEδa. The map shown in FIG. 16 is used when DP is DPREFa. Although not shown, in the map used when DP is DPREFb, regions αb, βb, γb, and δb are set. If NE and QAIR are provided in each of the regions αb, βb, γb, and δb, the basic value BASELMH is set for each of predetermined first, second, third, and fourth basic values BASEαb, BASEβb, BASEγb, and BASEδb. The first to fourth basic values BASEαb to BASEδb are respectively set at smaller values than the first to fourth basic values BASEαa to BASEδa.

Also, in the map used when DP is DPREFc, regions αc, βc, γc, and δc are set. If NE and QAIR are provided in each of the regions αc, βc, γc, and δc, the basic value BASELMH is set for each of predetermined first, second, third, and fourth basic values BASEαc, BASEβc, BASEγc, and BASEδc. The first to fourth basic values BASEαc to BASEδc are respectively set at smaller values than the first to fourth basic values BASEαb to BASEγb. Further, in the map used when DP is DPREFd, regions αd, βd, γd, and δd are set. If NE and QAIR are provided in each of the regions αd, βd, γd, and δd, the basic value BASELMH is set for each of predetermined first, second, third, and fourth basic values BASEαd, BASEβd, BASEγd, and BASEδd. The first to fourth basic values BASEαd to BASEδd are respectively set at smaller values than the first to fourth basic values BASEαc to BASEδc.

As described above, the basic value BASELMH is set at a smaller value as the pressure deviation DP is smaller. This is because, as the pressure deviation DP is smaller, that is, as the injection pressure of the ethanol E by the port injection valve 7 is lower with respect to the pressure at the intake air port 4a, the port injection quantity to be injected is decreased for the same valve open period of the port injection valve 7. If the pressure deviation DP is different from any one of the first to fourth predetermined values DPREFa to DPREFd, the basic value BASELMH is calculated by interpolation arithmetic operation.

Also, in the above-described four maps, the regions αa to αd each are set in an extremely high output region in which the output of the engine 3 (hereinafter, referred to as “engine output”) expressed by the engine speed NE and the intake air quantity QAIR is extremely high, and the regions βa to βd each are set in a high output region in which the engine output is relatively high and is lower than those in the regions αa to αd. Also, the regions γa to γd each are set in a medium output region in which the engine output is medium and is lower than those in the regions βa to βd, and the regions δa to δd each are set in a low-medium output region in which the engine output is from low to medium and is lower than those in the regions γa to γd. Further, the magnitude relationship among the first to fourth basic values BASEαa to BASEαa is set in the order of BASEαa<BASEβa<BASEγa<BASEαa. The magnitude relationship among the first to fourth basic values BASEαb to BASEαb is set in the order of BASEαb<BASEβb<BASEγb<BASEδb. The magnitude relationship among the first to fourth basic values BASEαc to BASEδc is set in the order of BASEαc<BASEβc<BASEγc<BASEαc. The magnitude relationship among the first to fourth basic values BASEαd to BASEδd is set in the order of BASEαd<BASEPd<BASEγd<BASEδd. In this way, the basic value BASELMH is calculated at a smaller value as the engine output is higher by the following reason.

As the engine output is higher and the engine speed NE is higher, the period per one combustion cycle of the engine 3 is decreased, hence the valve open period of the port injection valve 7 in which the ethanol E injected from the port injection valve 7 can be combusted in the combustion chamber 3d is decreased, and the fuel quantity by which injection is substantially available from the port injection valve 7 is further decreased. Also, as it is found from the calculation method of the above-described target in-cylinder injection quantity QINJ1, as the port injection ratio RF2 is larger, the in-cylinder injection quantity of the in-cylinder injection valve 6 is decreased. Accordingly, the injection hole portion of the in-cylinder injection valve 6 becomes less cooled by the gasoline G, and hence the temperature of the injection hole portion of the in-cylinder injection valve 6 (hereinafter, referred to as “tip end temperature”) is increased. Accordingly, a precursor substance of deposits is aggregated at the injection hole portion of the in-cylinder injection valve 6, and the deposits are likely accumulated. This tendency likely increases because the temperature in the combustion chamber 3d is increased as the engine output is higher and the intake air quantity QAIR is larger, and because the port injection ratio RF2 of the port injection valve 7 is limited to a smaller value as the engine output is higher, to prevent the accumulation of the deposits, and hence the in-cylinder injection quantity of the in-cylinder injection valve 6 is increased.

The fourth basic value BASEδa set at the largest value is set at a smaller value than the value 1.0 to save the ethanol E. Also, in the above-described setting of the basic value BASELMH, an appropriate parameter that correlates with the tip end temperature of the in-cylinder injection valve 6, for example, an engine water temperature TW may be used instead of the intake air quantity QAIR.

In step 113 subsequent to aforementioned step 112, retrieval is made from a predetermined map (not shown) in accordance with the knock intensity KNOCK, and hence a first correction coefficient COLMH1 is calculated. The first correction coefficient COLMH1 is used as a correction coefficient for correcting the basic value BASELMH to calculate an upper limit value RF2LMH. In the map, the first correction coefficient COLMH1 is set at a larger value being larger than the value 1.0 as the knock intensity KNOCK is higher. This is to reduce the limitation of the port injection ratio RF2 to properly restrict knocking of the engine 3 as the knock intensity KNOCK is higher.

Then, retrieval is made from a predetermined map (not shown) in accordance with the engine speed NE and the intake air quantity QAIR, and hence the upper limit value IGLMH of the ignition timing IG (a limit value at the retard side) is calculated (step 114). In this map, the upper limit value IGLMH is set at a value that can prevent excessive heating and unstable combustion of exhaust gas of the engine 3 by retardation of the ignition timing IG. The upper limit value IGLMH is set at a larger value (a value at the retard side) than the temporary ignition timing IGTEM for the same NE and QAIR.

Then, it is judged whether or not the ignition timing IG calculated in FIG. 8 or 10 is smaller than the upper limit value IGLMH calculated in aforementioned step 114 (step 115). If the answer is YES (IG<IGLMH), that is, if the ignition timing IG is not limited to the upper limit value IGLHM in aforementioned steps 35 and 36 in FIG. 8, a second correction coefficient COLMH2 is set at the value 1.0 (step 116), and the processing goes to step 118. The second correction coefficient COLMH2 is used as a correction coefficient for correcting the basic value BASELMH to calculate the upper limit RF2LMH similarly to the first correction coefficient COLMH1.

In contrast, if the answer in aforementioned step 115 is NO (IG≧IGLMH), that is, if the ignition timing IG is limited to the upper limit value IGLMH, the second correction coefficient COLMH2 is set at a first predetermined value COLMRE1 larger than the value 1.0 (step 117), and the processing goes to step 118. As described above, the correction of the basic value BASELMH by using the second correction coefficient COLMH2 is executed only when the ignition timing IG is limited to the upper limit value IGLMH, and the basic value BASELMH is increased by the correction.

In step 118 subsequent to step 116 or 117, it is judged whether or not a tip end temperature TEDI (the temperature of the injection hole portion of the in-cylinder injection valve 6) is lower than a predetermined upper limit temperature TELMH. The tip end temperature TEDI is detected by, for example, a sensor (not shown) configured of, for example, a thermistor. Alternatively, the tip end temperature TEDI may be calculated in accordance with various parameters that affect the temperature of the injection hole portion of the in-cylinder injection valve 6, for example, the engine speed NE, intake air quantity QAIR, ignition timing IG, engine water temperature TW, and injection period of the in-cylinder injection valve 6, as disclosed in Japanese Unexamined Patent Application Publication No. 2015-169184, the entire contents of which are incorporated herein by reference.

The above-described upper limit temperature TELMH is set at a slightly lower temperature than a temperature at which the deposits are generated at the injection hole portion of the in-cylinder injection valve 6 and the injection hole portion of the in-cylinder injection valve 6 is excessively heated. If the answer in step 118 is YES (TEDI<TELMH), a third correction coefficient COLMH3 is set at the value 1.0 (step 119), and the processing goes to aforementioned step 91. The third correction coefficient COLMH3 is used as a correction coefficient for correcting the basic value BASELMH to calculate the upper limit value RF2LMH similarly to the first correction coefficient COLMH1.

In contrast, if the answer in step 118 is NO (TEDI≧TELMH), the third correction coefficient COLMH3 is set at a smaller second predetermined value COLMRE2 than the value 1.0 (step 120), and the processing goes to step 91. In this way, the correction of the basic value BASELMH by using the third correction coefficient COLMH3 is executed only if the tip end temperature TEDI is the upper limit temperature TELMH or higher. The basic value BASELMH is decreased by the correction.

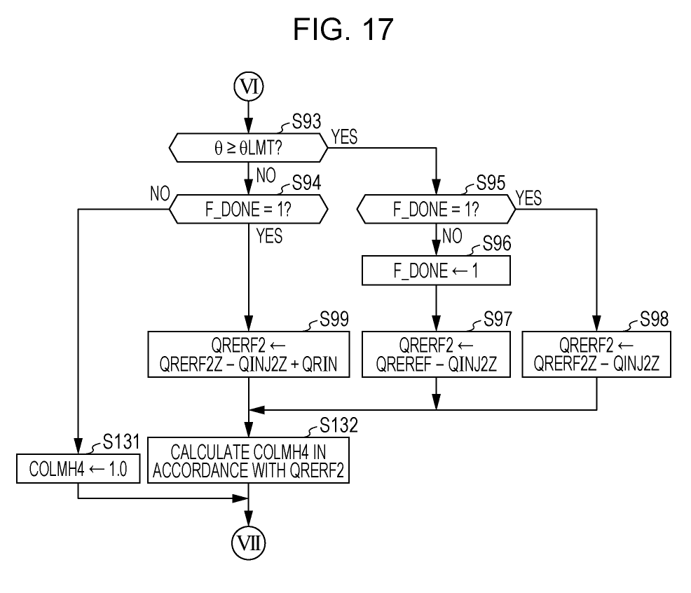

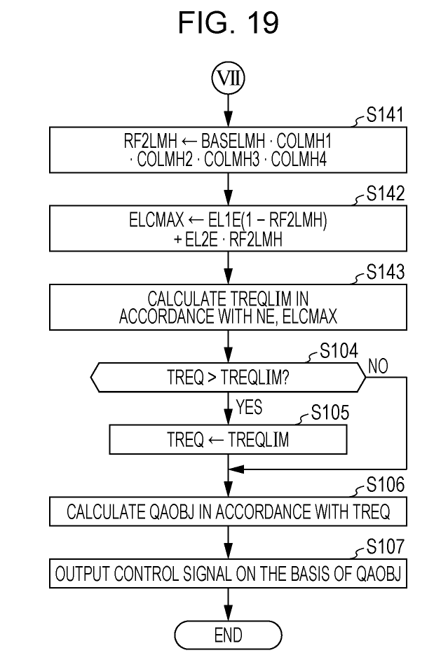

As shown in FIGS. 15 and 17, also in the second embodiment, aforementioned steps 93 to 99 are executed subsequently to aforementioned step 92, and in steps 97 to 99, the reservoir ethanol remaining quantity QRERF2 is calculated. If the answer in aforementioned step 94 in FIG. 17 is NO, unlike the first embodiment, a fourth correction coefficient COLMH4 is set at the value 1.0 (step 131), and the processing goes to step 141 in FIG. 19 (described later). The fourth correction coefficient COLMH4 is used as a correction coefficient for correcting the basic value BASELMH to calculate the upper limit value RF2LMH similarly to the first correction coefficient COLMH1.

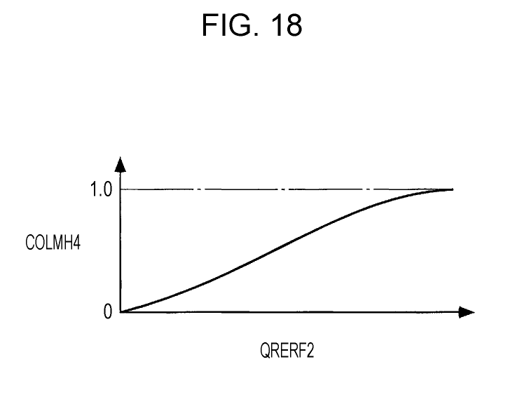

Also, in step 132 subsequent to step 97, 98, or 99 in FIG. 17, retrieval is made from a map shown in FIG. 18 in accordance with the calculated reservoir ethanol remaining quantity QRERF2, and hence a fourth correction coefficient COLMH4 is calculated. As shown in FIG. 18, in this map, the fourth correction coefficient COLMH4 is set at a positive value equal to or smaller than the value 1.0, and is set at a smaller value as the reservoir ethanol remaining quantity QRERF2 is smaller. If QRERF2 is at the value 0, the fourth correction coefficient COLMH4 is set at the value 0. This is to reduce consumption of the ethanol E and to gradually limit the output of the engine 3 by using the upper limit request torque TREQLIM (described above), by setting the upper limit value RF2LMH of the port injection ratio RF2 at a smaller value as the reservoir ethanol remaining quantity QRERF2 is smaller. The fourth correction coefficient COLMH4 may be calculated in accordance with the ratio between the reservoir ethanol remaining quantity QRERF2 and the predetermined value QREREF (QRERF2/QREREF).

In step 141 in FIG. 19 subsequent to step 131 or 132, the basic value BASELMH calculated in aforementioned step 112 in FIG. 15 is multiplied by the first correction coefficient COLMH1 calculated in step 113, the second correction coefficient COLMH2 set in step 116 or 117, the third correction coefficient COLMH3 set in step 119 or 120, and the fourth correction coefficient COLMH4 set in step 131 or 132, and hence an upper limit value RF2LMH is calculated. By the calculation, the upper limit value RF2LMH is calculated at the value 1.0 or smaller.

If aforementioned step 141 is executed, the calculated upper limit value RF2LMH is used for limitation of the port injection ratio RF2 in aforementioned step 24 in FIG. 7 in the knocking control processing. Also, although not shown in FIG. 9 or 11, the port injection ratio RF2 limited to the calculated upper limit value RF2LMH or smaller is used for calculation of the target port injection quantity QINJ2 in step 43 in FIG. 9 and step 82 in FIG. 11 in the non-knocking control processing.

In step 142 subsequent to step 141, an in-cylinder supply maximum octane value ELCMAX is calculated by Expression (1) as follows, by using the first and second estimated ethanol concentrations ELIE and EL2E respectively calculated in aforementioned steps 2 and 3 in FIG. 6 and the upper limit value RF2LMH calculated in aforementioned step 141. As it is found from Expression (1), the in-cylinder supply maximum octane value ELCMAX is the maximum value of the ethanol concentration of the fuel that can be supplied into the combustion chamber 3d, and corresponds to the maximum value of the octane value of the fuel that can be supplied into the combustion chamber 3d. Alternatively, the in-cylinder supply maximum octane value ELCMAX may be calculated by map retrieval in accordance with EL1E, EL2E, and RF2LMH.

ELCMAX←EL1E(1−RF2LMH)+EL2E·RF2LMH (1)

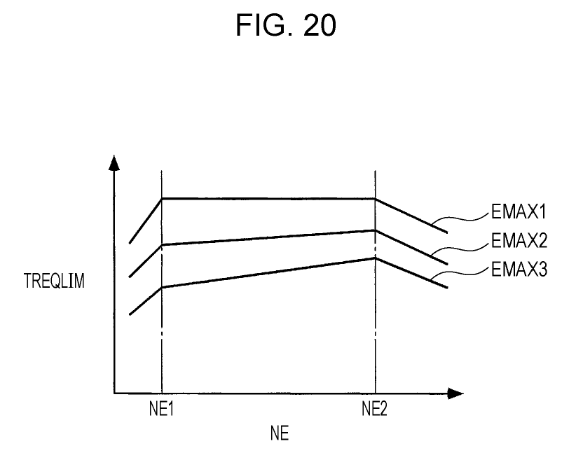

Then, retrieval is made from a map shown in FIG. 20 in accordance with the engine speed NE and the calculated in-cylinder supply maximum octane value ELCMAX, and hence an upper limit request torque TREQLIM is calculated (step 143). For this map, three maps are set for calculating the upper limit request torque TREQLIM for each of cases where the in-cylinder supply maximum octane value ELCMAX is a predetermined first maximum octane value EMAX1, a predetermined second maximum octane value EMAX2, and a predetermined third maximum octane value EMAX3. The magnitude relationship among the first to third maximum octane values EMAX1 to EMAX3 is set in the order of EMAX1>EMAX2>EMAX3. Also, if the in-cylinder supply maximum octane value ELCMAX is not any one of the first to third maximum octane values EMAX1 to EMAX3, the upper limit request torque TREQLIM is calculated by interpolation arithmetic operation.

Also, as shown in FIG. 12, in these maps, the upper limit request torque TREQLIM is set at a smaller value as the in-cylinder supply maximum octane value ELCMAX is smaller. Accordingly, the request torque TREQ is limited to a smaller value as the in-cylinder supply maximum octane value ELCMAX is smaller. Also, the upper limit request torque TREQLIM is set at the maximum torque value that reliably restricts knocking of the engine 3 when the port injection ratio RF2 is set at the upper limit value RF2LMH, that is, when the concentration of the ethanol component of the fuel to be supplied to the combustion chamber 3d is adjusted at the in-cylinder supply maximum octane value ELCMAX.

Further, the upper limit request torque TREQLIM is set at the larger value with the relatively large gradient as NE is higher in the extremely low rotation region in which the engine speed NE is lower than the first speed NE1, is set at the larger value with the relatively small gradient as NE is higher in the low to high rotation region in which NE is NE1 or higher and lower than the predetermined second speed NE2 (>NE1), and is set at the smaller value with the relatively large gradient as NE is higher in the high rotation region in which NE is NE2 or higher. The setting of the upper limit request torque TREQLIM is based on the relationship between the engine speed NE and the output torque of the engine 3, and hence is similar to the relationship between the number of rotations of a typical internal-combustion engine and the output torque.

Also, subsequently to aforementioned step 143, aforementioned steps 104 to 107 are executed, hence the request torque TREQ is limited by using the upper limit request torque TREQLIM calculated in step 143, the intake air quantity QAIR is controlled on the basis of the request torque TREQ, and then this processing is ended.

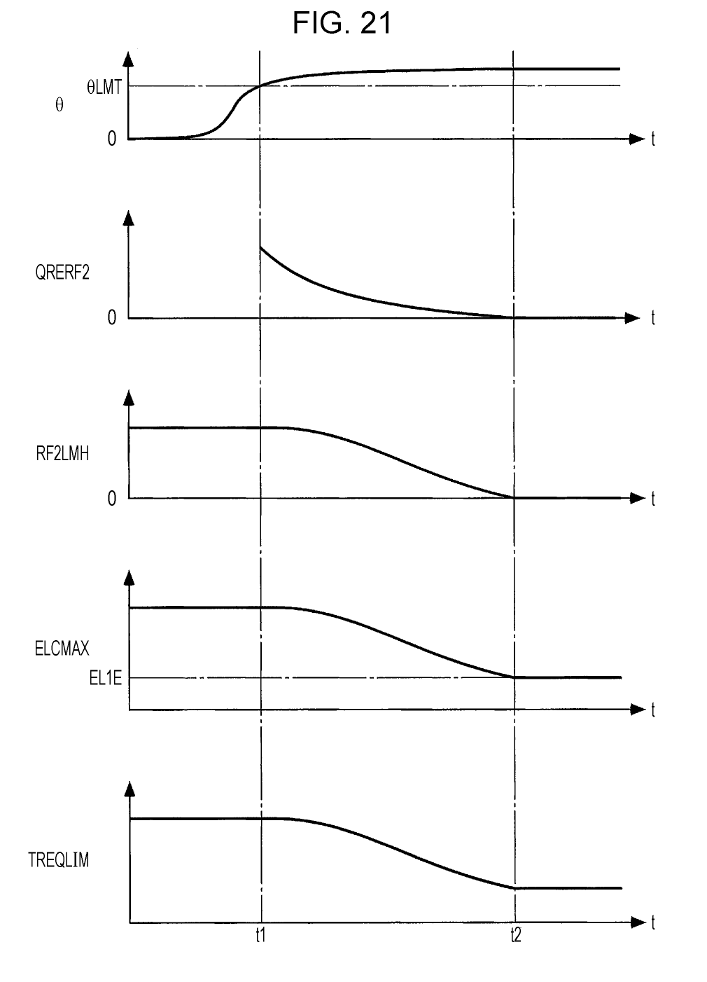

FIG. 21 shows an operation example of the control device according to the second embodiment. As shown in FIG. 21, when the second fuel tank inclination angle θ reaches the upper limit inclination angle θLMT due to left turning of the vehicle (time point t1, step 93: YES in FIG. 17), calculation of the reservoir ethanol remaining quantity QRERF2 is started (step 97). In this case, if θ≧θLMT, as described above, the ethanol E in the tank main body 22b does not flow into the reservoir 22c, and the ethanol E in the reservoir 22c is consumed by injection with the port injection valve 7. Hence, the reservoir ethanol remaining quantity QRERF2 is decreased with elapse of time t (step 98).

Also, in this case, as it is found from the map (FIG. 18) for calculating the above-described fourth correction coefficient COLMH4, the upper limit value RF2LMH of the port injection ratio RF2 is calculated at a smaller value as the reservoir ethanol remaining quantity QRERF2 is smaller (step 141 in FIG. 19). Accordingly, the consumption of the ethanol E is reduced, and the decreasing speed of the reservoir ethanol remaining quantity QRERF2 is lowered. Also, as it is found from aforementioned Expression (1), the in-cylinder supply maximum octane value ELCMAX is calculated at a smaller value as the upper limit value RF2LMH is smaller (step 142). Accordingly, the upper limit request torque TREQLIM is calculated at a smaller value, and is calculated at the maximum torque value that reliably restricts knocking of the engine 3 with respect to the in-cylinder supply maximum octane value ELCMAX (step 143). In this way, the output (torque) of the engine 3 is gradually limited as the reservoir ethanol remaining quantity QRERF2 is decreased.

Then, if the reservoir ethanol remaining quantity QRERF2 becomes the value 0 (time point t2), the upper limit value RF2LMH is calculated at the value 0, and hence the port injection ratio RF2 is limited to (set at) the value 0. Accordingly, the target port injection quantity QINJ2 is calculated at the value 0, hence the injection operation of the ethanol E by the port injection valve 7 is stopped, and the gasoline G is injected from the in-cylinder injection valve 6 by the total fuel injection quantity QINJT. Also, in response to that the upper limit value RF2LMH is calculated at the value 0, the in-cylinder supply maximum octane value ELCMAX is calculated at the first estimated ethanol concentration EL1E. The upper limit request torque TREQLIM is calculated at the maximum torque value that reliably restricts knocking when only the gasoline G is supplied to the engine 3 (ELCMAX=EL1E).

In this way, according to the second embodiment, if the second fuel tank inclination angle θ is the upper limit inclination angle θLMT or larger (step 93: YES in FIG. 17) as described with reference to FIG. 21 and other drawings, the output of the engine 3 is gradually limited as the reservoir ethanol remaining quantity QRERF2 is decreased (step 132 in FIG. 17, FIG. 18, steps 141 to 143, and 104 to 107 in FIG. 19). Accordingly, the phenomenon in which the output of the engine 3 is rapidly limited and the driver feels uncomfortable can be prevented from occurring while knocking of the engine 3 is restricted.

In this case, as the reservoir ethanol remaining quantity QRERF2 is smaller, the upper limit value RF2LMH of the port injection ratio RF2 is set at a smaller value, and the in-cylinder supply maximum octane value ELCMAX corresponding to the maximum value of the octane value of the fuel that can be supplied into the cylinder 3a is calculated in accordance with the upper limit value RF2LMH. Also, the upper limit request torque TREQLIM used for limitation of the output of the engine 3 is calculated in accordance with the in-cylinder supply maximum octane value ELCMAX. In this way, the upper limit request torque TREQLIM is set at the maximum torque value that reliably restricts knocking of the engine 3 when the port injection ratio RF2 is set at the upper limit value RF2LMH, that is, when the concentration (octane value) of the ethanol component of the fuel to be supplied to the cylinder 3a is adjusted at the in-cylinder supply maximum octane value ELCMAX. Accordingly, knocking can be properly restricted without excessive limitation on the output of the engine 3 while the consumption of the ethanol E in the reservoir 22c is held at the level corresponding to the limitation of the output of the engine 3.

The present disclosure is not limited to the above-described first and second embodiments (hereinafter, collectively referred to as “embodiment”), and may be implemented in various forms. For example, in the embodiment, the second fuel tank inclination angle θ is detected; however, calculation may be executed on the basis of, for example, the lateral acceleration of the vehicle, the steering angle of the vehicle, or the yaw rate of the vehicle detected by a sensor. Further, in the embodiment, the second fuel tank inclination angle θ is used as the inclination state of the high octane fuel tank according to this disclosure; however, another appropriate parameter, for example, the lateral acceleration of the vehicle, the steering angle of the vehicle, or the yaw rate of the vehicle may be used. Also, in the embodiment, the reservoir ethanol remaining quantity QRERF2 is calculated; however, the reservoir ethanol remaining quantity QRERF2 may be detected by a sensor. In this case, a sensor of float type or capacitance type may be used.

Further, in the embodiment, the limitation on the output of the internal-combustion engine according to this disclosure is executed by correcting the request torque TREQ to be decreased, which is used for the control on the intake air quantity; however, may be executed by correcting the target intake air quantity QAOBJ to be decreased, or by correcting the ignition timing to be retarded.

Also, in the embodiment, as the high octane fuel tank according to this disclosure, the second fuel tank 22 is used, in which the intake passage 22d is provided at the center in the front-rear direction of the wall surface on the left of the bottom portion of the reservoir 22c. However, a fuel tank in which an intake passage is provided at the center in the left-right direction of the wall surface on the front or rear of the bottom portion of the reservoir may be used. If the fuel tank in which the intake passage is provided at the wall surface on the front or rear of the bottom portion of the reservoir is used, as the inclination state of the high octane fuel tank according to this disclosure, for example, the rearward or forward inclination angle of the high octane fuel tank with respect to the horizontal line extending in the front-rear direction of the vehicle, the acceleration or deceleration of the vehicle, the opening degree of the accelerator pedal, or the opening degree of the brake pedal may be used. Such a parameter may be detected by a sensor, or may be calculated (estimated).

Further, in the embodiment, the second fuel tank 22 provided with the reservoir 22c is used as the high octane fuel tank according to this disclosure; however, a fuel tank without a reservoir may be used. In this case, for the first embodiment, for example, when the acquired inclination angle of the high octane fuel tank is larger than a predetermined value and when the acquired remaining quantity of the high octane fuel in the high octane fuel tank reaches a predetermined lower limit value, it is recognized that the high octane fuel in the high octane fuel tank cannot be sucked by a pump, and the output of the internal-combustion engine is limited. Also, for the second embodiment, for example, when the acquired inclination angle of the high octane fuel tank is larger than a predetermined value on the basis of the remaining quantity of the high octane fuel, it is recognized that the high octane fuel cannot be sufficiently sucked by a pump. The output of the internal-combustion engine is gradually limited in accordance with that the remaining quantity of the high octane fuel is decreased.

Also, the setting methods of the port injection ratio RF2 and the ignition timing IG described in the embodiment are merely examples, and as a matter of course, other appropriate setting methods may be employed within the scope of this disclosure. Further, in the embodiment, the first and second ethanol concentrations EL1 and EL2 are respectively detected by the first and second concentration sensors 39 and 40. However, for example, estimation (calculation) may be executed as follows. When the load of the internal-combustion engine is in a predetermined low octane value judgment region, only the low octane fuel (gasoline G) is supplied to the internal-combustion engine, and the ignition timing is once changed to the retard side from the normal ignition timing (the temporary ignition timing IGTEM), and then, the ignition timing is gradually changed to the advance side. The above-described low octane value judgment region is set in a region on the low load side in the load region in which knocking of the internal-combustion engine may be generated (hereinafter, referred to as “knock region”) unless the ignition timing of the internal-combustion engine is controlled to the retard side with respect to the normal ignition timing or the high octane fuel (the ethanol E) is supplied to the internal-combustion engine in addition to the low octane fuel. While the ignition timing is changed to the advance side as described above, the presence of knocking of the internal-combustion engine is detected, a plurality of operating parameters that specify the operating condition of the internal-combustion engine, such as the ignition timing at the time point at which knocking is generated, the load of the internal-combustion engine, the number of rotations of the internal-combustion engine, and the execution compression ratio are acquired, and the first ethanol concentration (the octane value of the low octane fuel) is calculated (estimated) by map retrieval on the basis of the acquired operating parameters.

Also, the second ethanol concentration (the octane value of the high octane fuel) is estimated as follows. When the load of the internal-combustion engine is in a predetermined high octane value judgment region on the high load side with respect to the low octane value judgment region, the supply quantities of the low octane fuel and high octane fuel are controlled similarly to steps 42 to 45 in FIG. 9, and the ignition timing is changed from the normal ignition timing to the advance side. While the ignition timing is changed to the advance side as described above, the presence of knocking of the internal-combustion engine is detected, the plurality of operating parameters that specify the operating condition of the internal-combustion engine, such as the port injection ratio RF2, first ethanol concentration, ignition timing, load of the internal-combustion engine, number or rotations of the internal-combustion engine, and execution compression ratio at the time point at which knocking is generated are acquired, retrieval is made from a map based on the acquired operating parameters, and hence the second ethanol concentration is calculated (estimated).

Alternatively, focusing on that, since the above-described stoichiometric mixture ratio is different between the gasoline G and the ethanol E, the fuel injection quantity required for holding the air fuel ratio LAF at the predetermined value is increased as the ethanol concentration (octane value) of the mixed fuel including both G and E is higher, the first and second ethanol concentrations may be estimated as follows. When the load of the internal-combustion engine is in a predetermined non-knock region and is constant, a moving average value of a correction coefficient KINJ that is calculated on the basis of the above-described air fuel ratio LAF is calculated, the basic fuel injection quantity QINJB at the time point at which the moving average value is calculated is multiplied by a value obtained by subtracting the port injection ratio RF2 from the value 1.0, and hence a first reference injection quantity is calculated. The non-knock region described above is set in a region on the low load side so that knocking of the internal-combustion engine is not generated even when only the low octane fuel is supplied to the internal-combustion engine. Then, a current first ethanol concentration is calculated (estimated) in accordance with the calculated moving average value and first reference injection quantity, and the previous value of the first ethanol concentration.

Also, the second ethanol concentration (the octane value of the high octane fuel) is estimated as follows. When the load of the internal-combustion engine is in the knock region and is constant, a moving average value of the correction coefficient KINJ calculated on the basis of the above-described air fuel ratio LAF is calculated, and the basic fuel injection quantity QINJB at the time point at which the moving average value is calculated is set as a second reference injection quantity. Then, a current second ethanol concentration is calculated (estimated) in accordance with the calculated moving average value and second reference injection quantity, and the previous values of the first and second ethanol concentrations.

Also, in the embodiment, the first and second estimated ethanol concentrations EL1E and EL2E are respectively calculated as the octane values of the gasoline G and the ethanol E. However, the detected first and second ethanol concentrations EL1 and EL2 may be used. The octane values of the gasoline G and the ethanol E may be respectively calculated on the basis of EL1E and EL2E or EL1 and EL2. Alternatively, the octane values of the gasoline G and the ethanol E may be detected by using sensors that output detection signals indicative of the octane values based on the first and second ethanol concentrations EL1 and EL2. Further, the calculation method of the upper limit value RF2LMH described in the second embodiment is merely an example, and at least one of the first to third coefficients COLMH1 to CLMH3 may be omitted, or the calculation method of the basic value BASELMH may be changed.

Also, in the embodiment, the gasoline G serving as the low octane fuel is injected into the cylinder 3a, and the ethanol E serving as the high octane fuel is injected into the intake air port 4a. However, in contrast, the low octane fuel may be injected into the intake air port, and the high octane fuel may be injected into the cylinder. Alternatively, the low octane fuel and the high octane fuel may be previously mixed in a state with an adjusted ratio, and the mixed fuel may be supplied into the cylinder by using a single injection valve.

Further, the embodiment is an example in which the present disclosure is applied to the engine 3 that generates the ethanol E serving as the high octane fuel by separating the ethanol component (the high octane component) from the gasoline G serving as the low octane fuel. However, the present disclosure is not limited thereto, and may be applied to an internal-combustion engine in which the low octane fuel and the high octane fuel are supplied to different fuel tanks from the outside. Also, in the embodiment, the gasoline G and the ethanol E are respectively used as the low octane fuel and the high octane fuel. However, other appropriate fuels having different octane values may be used.

Further, in the embodiment, the internal-combustion engine according to the present disclosure is the engine 3 for vehicle. However, another appropriate industrial internal-combustion engine, for example, an internal-combustion engine for ship may be used. It is to be noted that, as a matter of course, the above-described variations relating to the embodiment may be properly combined and applied. In addition, the configurations of the specific components can be properly changed within the scope of this disclosure.

According to a first aspect of the present disclosure, a control device for an internal-combustion engine that uses in combination low octane fuel (in an embodiment (the same is applied to the following description), gasoline) stored in a low octane fuel tank (a first fuel tank) and high octane fuel (ethanol) having a higher octane value than an octane value of the low octane fuel and stored in a high octane fuel tank (a second fuel tank) is provided. The control device includes an inclination state acquiring unit (an inclination sensor) that acquires an inclination state of the high octane fuel tank; a remaining quantity acquiring unit (an ECU, steps 97 to 99 in FIGS. 12 and 17) that acquires a remaining quantity of the high octane fuel in the high octane fuel tank; and an output limiting unit (the ECU, step 93 in FIG. 12, steps 101, and 104 to 107 in FIG. 13, step 132 in FIG. 17, FIG. 18, steps 141 to 143, and 104 to 107 in FIG. 19, FIG. 20) that limits output of the internal-combustion engine in accordance with the acquired inclination state (a second fuel tank inclination angle) of the high octane fuel tank and the acquired remaining quantity (a reservoir ethanol remaining quantity) of the high octane fuel.

With this configuration, the inclination state of the high octane fuel tank is acquired by the inclination state acquiring unit, and the remaining quantity of the high octane fuel in the high octane fuel tank is acquired by the remaining quantity acquiring unit. Also, the output of the internal-combustion engine is limited by the output limiting unit in accordance with the acquired inclination state of the high octane fuel tank and the acquired remaining quantity of the high octane fuel. Knocking of an internal-combustion engine tends to be more likely generated as the output is higher. Hence, the output limiting unit limits the output of the internal-combustion engine in a case where the high octane fuel cannot be sufficiently supplied into a cylinder due to an inclination of the high octane fuel tank and a decrease in the remaining quantity of the high octane fuel. Accordingly, knocking of the internal-combustion engine can be restricted.

According to a second aspect of the present disclosure, in the control device for the internal-combustion engine described in the first aspect, the output limiting unit may limit the output of the internal-combustion engine (steps 103 to 107 in FIG. 13) when the remaining quantity of the high octane fuel reaches a predetermined lower limit value (step 101: YES in FIG. 13) in a case where the inclination state of the high octane fuel tank is a predetermined inclination state (step 93: YES in FIG. 12).

With this configuration, the output of the internal-combustion engine may be limited when the remaining quantity of the high octane fuel reaches the lower limit value in the case where the inclination state of the high octane fuel tank is the predetermined inclination state. In this way, the output of the internal-combustion engine is limited after the remaining quantity of the high octane fuel actually decreases to the predetermined lower limit value in addition to that the high octane fuel tank is inclined. Accordingly, the limitation can be prevented from being unnecessarily executed.

According to a third aspect of the present disclosure, in the control device for the internal-combustion engine described in the first aspect, the output limiting unit may gradually limit the output of the internal-combustion engine (step 132 in FIG. 17, FIG. 18, steps 141 to 143, and 104 to 107 in FIG. 19, FIG. 20) in accordance with that the remaining quantity of the high octane fuel decreases in a case where the inclination state of the high octane fuel tank is a predetermined inclination state (step 93: YES in FIG. 17).

With this configuration, the output of the internal-combustion engine may be gradually limited in accordance with that the remaining quantity of the high octane fuel decreases in the state where the inclination state of the high octane fuel tank is the predetermined inclination state. Accordingly, a phenomenon in which the output of the internal-combustion engine is rapidly limited and the driver feels uncomfortable can be prevented from occurring while knocking of the internal-combustion engine is restricted.

Obviously, numerous modifications and variations of the present invention are possible in light of the above teachings. It is therefore to be understood that within the scope of the appended claims, the invention may be practiced otherwise than as specifically described herein.

What is claimed is:

1. A control device for an internal-combustion engine that uses in combination low octane fuel stored in a low octane fuel tank and high octane fuel having a higher octane value than an octane value of the low octane fuel and stored in a high octane fuel tank, the control device comprising:
an inclination state acquiring unit that acquires an inclination state of the high octane fuel tank;
a remaining quantity acquiring unit that acquires a remaining quantity of the high octane fuel in the high octane fuel tank; and
an output limiting unit that limits output of the internal-combustion engine in accordance with the acquired inclination state of the high octane fuel tank and the acquired remaining quantity of the high octane fuel.

2. The control device according to claim 1, wherein the output limiting unit limits the output of the internal-combustion engine when the remaining quantity of the high octane fuel reaches a predetermined lower limit value in a case where the inclination state of the high octane fuel tank is a predetermined inclination state.

3. The control device according to claim 1, wherein the output limiting unit gradually limits the output of the internal-combustion engine in accordance with that the remaining quantity of the high octane fuel decreases in a case where the inclination state of the high octane fuel tank is a predetermined inclination state.

4. A control device for an internal-combustion engine to utilize low octane fuel and high octane fuel having a high octane value higher than a low octane value of the low octane fuel, the control device comprising:
an inclination state sensor to detect an inclination state of a high octane fuel tank to store the high octane fuel; and
a computer processor to
acquire a remaining quantity of the high octane fuel in the high octane fuel tank, and
restrict a power generated by the internal-combustion engine in accordance with the inclination state and the remaining quantity.

5. The control device according to claim 4, wherein the computer processor restricts the power generated by the internal-combustion engine when the remaining quantity reaches a predetermined lower limit value in a case where the inclination state is a predetermined inclination state.

6. The control device according to claim 4, wherein the computer processor gradually restricts the power generated by the internal-combustion engine in accordance with that the remaining quantity decreases in a case where the inclination state is a predetermined inclination state.
